(19) United States
(12) Patent Application Publication
(10) Pub. No.: US 2026/0042582 A1
(43) Pub. Date: Feb. 12, 2026

(54) PORTABLE CONTAINER SYSTEM

(71) Applicant: YETI Coolers, LLC, Austin, TX (US)

(72) Inventors: Dustin R. Bullock, Austin, TX (US); Alexander Munao, Austin, TX (US)

(21) Appl. No.: 19/225,779

(22) Filed: Jun. 2, 2025

Related U.S. Application Data
(60) Provisional application No. 63/680,883, filed on Aug. 8, 2024.

(51) Int. Cl. B65D 51/16; B65D 39/08; B65D 39/16; B65D 43/02; B65D 81/38

(52) U.S. Cl. CPC B65D 51/1688; B65D 39/08; B65D 39/16; B65D 43/0229; B65D 81/3841; B65D 2205/00

(57) ABSTRACT

A container system comprises a container with a storage compartment and a lid assembly to seal the container. The lid assembly includes an upper portion and a lower portion that are moveably coupled to one another. The upper portion includes a vent gasket that contacts the lower portion to seal a vent opening in the lower portion, and the lower portion includes a lower gasket to seal the lower portion to the container. When removing the lid assembly, the upper portion is moved relative to the lower portion a predetermined amount causing the vent gasket to be free of contact from the lower portion creating a vent path for air to escape from the storage compartment.

### CROSS-REFERENCE TO RELATED MATTERS

This application claims priority to U.S. Provisional Application No. 63/680,883 filed on Aug. 8, 2024, which is incorporated by reference herein in its entirety.

### FIELD OF THE INVENTION

This disclosure relates to portable containers. More specifically, aspects of this disclosure relate to a portable container with a lid, where when the container is in a closed configuration, the container provides a watertight and airtight seal.

### BACKGROUND

Portable containers are commonly used to store various items such as food or liquids. The containers may also provide a degree of protection from incidental impacts (e.g., drops) as well as from incursion from liquids or dirt. By sealing the container, the contents are prevented from leaking onto other items when stored and also protected from incursion into the contents. Containers may be composed of rigid materials and have an opening that may be sealed with a lid.

A container may be configured to store a volume of liquid, food, or any other item. In one example, an opening in the container may be sealed with a removable cap. Depending upon the items stored in the container, in some situations, the internal pressure within the container may become very high.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

This disclosure may relate to a container system comprising: (a) a container that includes (1) a sidewall structure having a top end and a bottom end; (2) a bottom portion connected to the bottom end; (3) a container opening in the top end extending into a storage compartment; and (4) a container engaging portion located on an interior surface of the sidewall structure near the top end; and (b) a lid assembly adapted to seal the container opening, where the lid assembly comprises: (1) an upper portion comprising a top wall, a sidewall portion below the top wall, where the sidewall portion comprises an upper engaging portion that engages the container engaging portion, a bottom wall connected to the sidewall portion, and a vent plug extending from the bottom wall, and (2) a lower portion releasably connected with the upper portion, the lower portion comprising a base, a lower engaging portion engaged with the container engaging portion, a lower gasket configured to engage the interior surface of the container, and a vent opening formed in the base. When the container system is in a closed configuration, the vent plug may be configured to contact the lower portion to seal the vent opening. The container engaging portion may comprise an internal threaded portion, and the upper engaging portion may comprise a first external threaded portion. Similarly, the lower engaging portion may comprise a second external threaded portion. The first external threaded portion may be longer than the second external threaded portion. The second external threaded portion may have a thickness that is greater than a thickness of the first external threaded portion. The upper portion and the lower portion may be rotatably coupled. In the closed configuration, the first external threaded portion and the second external threaded portion may form a single continuous thread, and in an open configuration the upper portion may be rotated relative to the lower portion such that a gap is formed between the first external threaded portion and the second external threaded portion. The vent plug of the upper portion may comprise a receiver in a lower surface of the vent plug. The lower portion may comprise a recess, where the recess of the lower portion is ring-shaped defining a projection. The projection may be at least partially received in the receiver when the container system is in the closed configuration. The upper portion may comprise an interior cavity that is at least partially enclosed by the top wall, the sidewall portion, and an upper magnet is secured within the interior cavity, and the lower portion may comprise a lower magnet and a magnetic force between the upper magnet and the lower magnet releasably connect the upper portion and the lower portion. The upper portion and the lower portion are moveably coupled. The bottom wall of the upper portion may comprise a pocket formed in a bottom surface, where the pocket defines a first step and a second step. The lower portion may comprise a tab extending upward from an upper surface, where the tab is configured to contact either the first step or the second step to stop relative movement of the upper portion and the lower portion. A vent area may be within a range of 1% and 15% of an opening area of the container opening.

Other aspects of this disclosure may relate to a container system comprising: (a) a container that includes: (1) a sidewall structure having a top end and a bottom end, (2) a bottom portion connected to the bottom end, (3) a container opening in the top end extending into a storage compartment, and (4) a container engaging portion on an inner surface of the sidewall structure near the top end, and (b) a lid assembly adapted to seal the container opening, where the lid assembly comprises (1) an upper portion that includes a sidewall portion comprising an upper engaging portion that engages the container engaging portion, a bottom wall connected to the sidewall portion, a vent plug extending from the bottom wall, and (2) a lower portion that is moveably coupled to the upper portion, where the lower portion comprises a base, a lower engaging portion that engages the container engaging portion, and a vent opening formed in the base. When the lid assembly is removed from the container, the upper portion moves relative to the lower portion causing the vent plug to be free of contact with the lower portion allowing air to escape from the storage compartment. In some examples, an opening torque required to begin removing the lid assembly from the container may be less than or equal to 8 N*m when an internal pressure of the storage compartment is within a range of 8 psi and 17 psi. A vent area may be within a range of 1% and 15% of an opening area of the container opening. The container engaging portion may be an internal threaded portion. In addition, the upper engaging portion may be a first external threaded portion and the lower engaging portion may be a second external threaded portion, where the first external threaded portion and the second external threaded portion when connected form a single continuous thread that engages the internal threaded portion. The bottom wall of the upper portion may include a pocket formed in a bottom surface, where the pocket defines a first step and a second step such that the first step and the second step converge toward each other. The lower portion may comprise a tab extending upward from an upper surface, where the tab is configured to contact either the first step or the second step when the lid assembly is installed or removed.

Additional aspects of this disclosure may relate to a container system comprising: (a) a container that includes: (1) a sidewall structure having a top end and a bottom end, (2) a bottom portion connected to the bottom end, (3) a container opening in the top end extending into a storage compartment, and (4) an internal threaded portion on an inner surface of the sidewall structure near the top end, and (b) a lid assembly adapted to seal the container opening, where the lid assembly comprises: (1) an upper portion that includes a sidewall portion that has a first external threaded portion that engages the internal threaded portion, a bottom wall connected to the sidewall portion, a vent plug extending from the bottom wall, and (2) a lower portion rotationally coupled to the upper portion, where the lower portion includes a base, a second external threaded portion that engages the internal threaded portion, and a vent opening formed in the base. When the container system is in a closed configuration, the first external threaded portion and the second external threaded portion may form a single continuous thread. And when the container system is in an open configuration, the upper portion may be rotated relative to the lower portion such that a gap is formed between an end of the first external threaded portion and an end of the second external threaded portion. The upper portion of the lid assembly may further comprise a pocket formed in the bottom wall, where the pocket defines a step, and the lower portion of the lid assembly further comprises a tab extending upward from the base. The vent plug may be configured to contact the lower portion to seal the vent opening when the container system is in the closed configuration. When removing the lid assembly from the container, the upper portion may move relative to the lower portion a predetermined amount causing the vent plug to be free of contact with the lower portion allowing air to escape from the storage compartment. As the upper portion moves beyond the predetermined amount, the tab may contact the step causing the lower portion to move in unison with the upper portion. An opening torque required to begin removing the lid assembly from the container may be less than or equal to 8 N*m when an internal pressure of the storage compartment is within a range of 8 psi and 17 psi. In some examples, the upper portion may comprise an upper magnet and the lower portion comprises a lower magnet, wherein a magnetic force between the upper magnet and the lower magnet releasably connect the upper portion and the lower portion.

### BRIEF DESCRIPTION OF THE DRAWINGS

FIG. 1 depicts a top, right, front perspective view of a portable container system in a closed configuration according to aspects disclosed herein;

FIG. 2 depicts a bottom, right, front perspective view of the portable container system of FIG. 1;

FIG. 3 depicts a top, right, front exploded perspective view of the portable container system of FIG. 1;

FIG. 4 depicts a front view of the portable container system of FIG. 1;

FIG. 5 depicts a top view of the portable container system of FIG. 1;

FIG. 6 depicts a bottom view of the portable container system of FIG. 1;

FIG. 7 depicts cross-sectional view of the portable container system of FIG. 5 along line 7-7 in a sealed configuration;

FIG. 8A depicts an enlarged view of a portion of cross-sectional view of the portable container system of FIG. 7 in a sealed configuration;

FIG. 8B depicts an enlarged view of an alternate cross-sectional view of the portable container system of FIG. 8A;

FIG. 9 depicts an enlarged view of a portion of cross-sectional view of FIG. 7 in a vented configuration;

FIG. 10 depicts a top, right, front perspective view of a lid assembly of the portable container system of FIG. 1;

FIG. 11 depicts a bottom, right, front perspective view of the lid assembly of FIG. 10;

FIG. 12 depicts a top, right, front exploded perspective view of the lid of FIG. 10;

FIG. 13 depicts a bottom, right, front exploded perspective view of the lid of FIG. 10;

FIG. 14A depicts a side view of the lid assembly of FIG. 10;

FIG. 14B depicts an enlarged view of a portion of FIG. 14A;

FIG. 14C depicts an enlarged view of a portion of FIG. 14A;

FIG. 15 depicts a side view of the lid assembly of FIG. 10 in a vented configuration;

FIG. 16 depicts a top view of a container of the container system of FIG. 1;

FIG. 17 depicts a bottom view of an upper portion of the lid assembly of the container system of FIG. 1;

FIG. 18 depicts a top, right, front perspective view of a portable container system in a closed configuration according to aspects disclosed herein;

FIG. 19 depicts a top, right, front exploded perspective view of the portable container system of FIG. 18 according to aspects disclosed herein;

FIG. 20 depicts a cross-sectional view of an alternate lid assembly of the portable container system of FIG. 18;

FIG. 21 depicts a bottom perspective view of a portion of the alternate lid assembly of FIG. 20 with some parts removed for clarity according to aspects disclosed herein;

FIG. 22 depicts a perspective exploded view of a portion of an alternate lid assembly for the portable container system of FIG. 1;

FIG. 23A depicts a perspective cross-sectional view of a portion of the lid assembly of FIG. 22 in an assembled configuration;

FIG. 23B depicts a front cross-sectional view of a portion of the alternate lid assembly of FIG. 22 in an assembled configuration;

FIG. 24 depicts a flowchart of a method of opening the container system of FIG. 1 according to aspects disclosed herein;

FIG. 25 depicts a flowchart of a method of closing the container system of FIG. 1 according to aspects disclosed herein;

FIG. 26 depicts a perspective view of an alternate lid assembly according to aspects disclosed herein;

FIG. 27 depicts a perspective view of the lid assembly of FIG. 26 according to aspects disclosed herein;

FIG. 28 depicts a perspective view of the lid assembly of FIG. 26 in a disassembled state;

FIG. 29 depicts a perspective view of an alternate lid assembly according to aspects disclosed herein;

FIG. 30 depicts an exploded perspective view of the lid assembly of FIG. 29;

FIG. 31 depicts an exploded perspective view of the lid assembly of FIG. 29 with some components removed for clarity;

FIG. 32 depicts a perspective view of an alternate lid assembly according to aspects disclosed herein;

FIG. 33 depicts an exploded perspective view of the lid assembly of FIG. 32;

FIG. 34 depicts an exploded perspective view of the lid assembly of FIG. 32 according to aspects disclosed herein;

FIG. 35 depicts a perspective view of an alternate lid assembly according to aspects disclosed herein;

FIG. 36 depicts an exploded perspective view of the lid assembly of FIG. 35;

FIG. 37 depicts a cross-sectional perspective view of the lid assembly of FIG. 35;

FIG. 38 depicts a top perspective view of an alternate lid assembly according to aspects disclosed herein;

FIG. 39 depicts an exploded top perspective view of the lid assembly of FIG. 38 in an unlocked configuration;

FIG. 40 depicts a bottom perspective view of an alternate lid assembly of FIG. 38 in an unlocked configuration;

FIG. 41 depicts a bottom perspective view of an alternate lid assembly of FIG. 38 in a locked configuration;

FIG. 42 depicts a perspective view of an alternate lid assembly according to aspects disclosed herein;

FIG. 43 depicts an exploded perspective view of the lid assembly of FIG. 42 in an unlocked configuration;

FIGS. 44A-44D depict perspective views of the lid assembly of FIG. 42 transitioning from a locked configuration to an unlocked configuration.

FIG. 45 depicts a perspective view of an alternate lid assembly in a locked configuration according to aspects disclosed herein;

FIG. 46 depicts a perspective view of the lid assembly of FIG. 45 in an unlocked configuration;

FIG. 47 depicts an exploded perspective view of the lid assembly of FIG. 45 in an unlocked configuration;

FIG. 48 depicts a lower portion of the lid assembly of FIG. 45; and

FIG. 49 depicts a partial perspective view of the lid assembly of FIG. 45 partially inserted into a container.

### DETAILED DESCRIPTION

In the following description of various example structures, reference is made to the accompanying drawings, which form a part hereof, and in which are shown by way of illustration various example devices, systems, and environments in which aspects may be practiced. It is to be understood that other specific arrangements of parts, example devices, systems, and environments may be utilized and structural and functional modifications may be made without departing from the scope of the present disclosure. Nothing in this specification should be construed as requiring a specific three dimensional orientation of structures in order to fall within the scope of this disclosure. The reader is advised that the attached drawings are not necessarily drawn to scale.

Also, while the terms “top,” “bottom,” “front,” “side,” and the like may be used in this specification to describe various example features and elements of the disclosed portably containers, these terms are used herein as a matter of convenience, e.g., based on the example orientations shown in the figures or the orientation during typical use. Additionally, the term “plurality,” as used herein, indicates any number greater than one, either disjunctively or conjunctively, as necessary, up to an infinite number.

The term “connect,” as used herein indicates that components, surfaces, or features and the like may be directly or indirectly (e.g., through an intermediary) joined, linked or attached.

As used herein, the term “substantially” means mostly, or almost the same as, within the constraints of sensible commercial engineering objectives, costs, manufacturing tolerances, and capabilities in the field of manufacturing the article being formed.

“Substantially coplanar” as used herein, indicates that the elements of any two or more surfaces or edges fall within a tolerance zone of parallel planes within a range of +/−2 mm of each other.

The term “magnetic,” as utilized herein, may refer to a material (e.g. a ferromagnetic material) that may be magnetized. As such, the term “magnetic” may imply that a material (e.g., a surface, or object, and the like) may be magnetically attracted to a magnet (e.g., a temporary or permanent magnet) that has an associated magnetic field. In one example, a magnetic material may be magnetized (e.g., may form a permanent magnet). Additionally, various examples of magnetic materials may be utilized with the disclosures described herein, including nickel, iron, and cobalt, and alloys thereof, among others.

In general, aspects of this disclosure relate to containers, container systems, canisters, lids, and containers with a lid or lid assembly. According to various aspects and examples, the containers and lid assemblies may be formed of one or more of a variety of materials, such as metals (including metal alloys), polymers, and composites, and may be formed in one of a variety of configurations, without departing from the scope of this disclosure. It is understood that the containers and lid assemblies may contain components made of several different materials. Additionally, the components may be formed by various forming methods. For example, metal components, may be formed by forging, molding, casting, stamping, machining, and/or other known techniques. Additionally, polymer components may be manufactured by polymer processing techniques, such as various molding and casting techniques and/or other known techniques. In some embodiments, a lower portion of a lid assembly may be formed of polyphenylene sulfide (PPS) plastic, which may be sufficiently rigid to resist deformation when the lower portion is subject to pressure. In some embodiments, the lower portion may be formed of PPS or another suitably rigid plastic to resist deformation when under pressure. Excessive deformation may cause the lower portion of the lid to transfer force to an upper portion of the lid assembly while under pressure, thereby increasing an opening torque for the lid assembly.

The various figures in this application illustrate examples of container systems with a container or canister and a lid assembly according to this disclosure. When the same reference number appears in more than one drawing, that reference number is used consistently in this specification and the drawings refer to the same or similar parts throughout.

Containers for food storage may be subject to pressurization depending on the temperature and type of the food. In many cases, this pressurization may be a result of gas formation from steam in the case of hot food stored in a sealed container. In some cases, micro-organisms may also generate gas that pressurizes a container when food is left in a container for a long period of time. Pressure within a container may apply force to both a container body and a closure such as a lid. Pressure applied to such a lid may result in high frictional forces that make removal of the lid to access the contents of the container difficult. In some conventional food storage containers, passive vents are installed which release pressure from a container above a certain threshold. However, such passive vents may be difficult to clean and may also release heat from the container, causing the stored food or other contents to cool more quickly. In other conventional containers, no passive ventilation may be provided, which accordingly restricts the use of a sealed container to certain contents (e.g., non-carbonated, dry, etc.) and temperatures (e.g., cold temperatures) that will not significantly pressurize the container.

In view of the foregoing, a container system may include a lid assembly that has an active vent. The active vent may be activated as the lid is opened to unseal the container to allow pressure to vent from the container. The active vent may have an effective pressure area significantly less than an area of the opening of the container sealed by the lid assembly. In some embodiments, the active vent may be a part of an upper lid portion that is positioned within an opening in a lower lid portion. The surface area of the active vent may be significantly less than the surface area of the lower lid portion, and as a result the force imparted on the upper lid portion via the active vent may be lower than the force imparted on the lower lid portion. Accordingly, the upper lid portion may be more easily moved to transition the active vent from a sealed configuration to an open configuration to release the pressure within the container, compared to the force to move the lower lid assembly to an open configuration. Once the container pressure is released, the lower lid portion may be moved to an open configuration. In some embodiments as discussed further herein, movement of the upper lid portion in a single direction (e.g., rotation) may first move the active vent from a sealed configuration to an open configuration, and subsequently move the lower lid portion from a closed configuration to an open configuration. Accordingly, the container system of exemplary embodiments described herein may provide low effective opening force for a user even when the container is pressurized in a single motion, without the presence of passive vents.

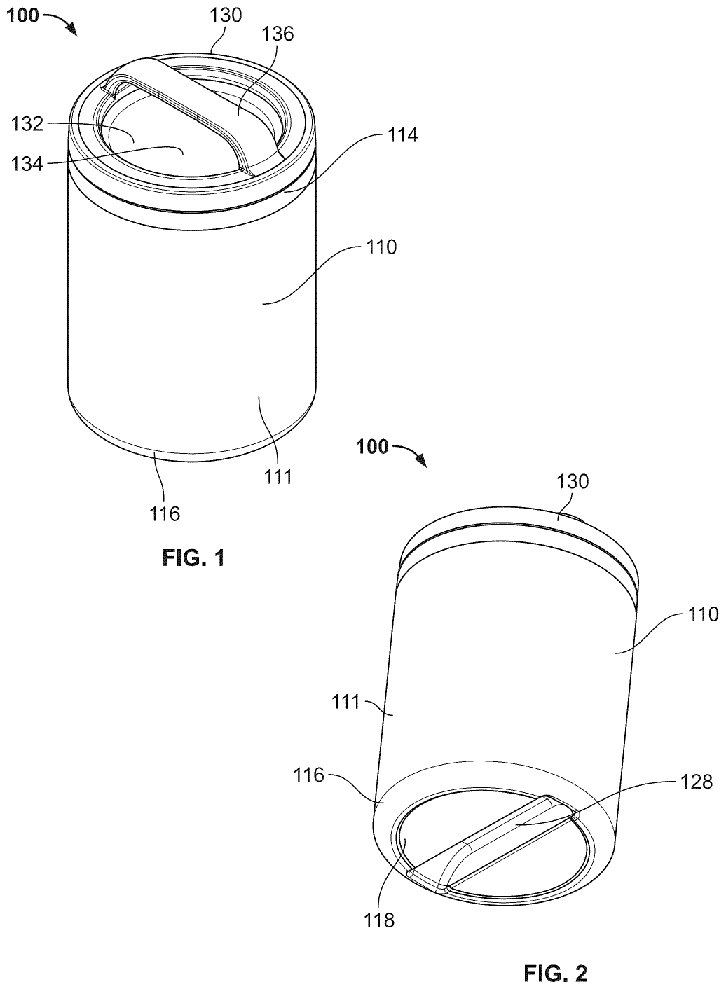

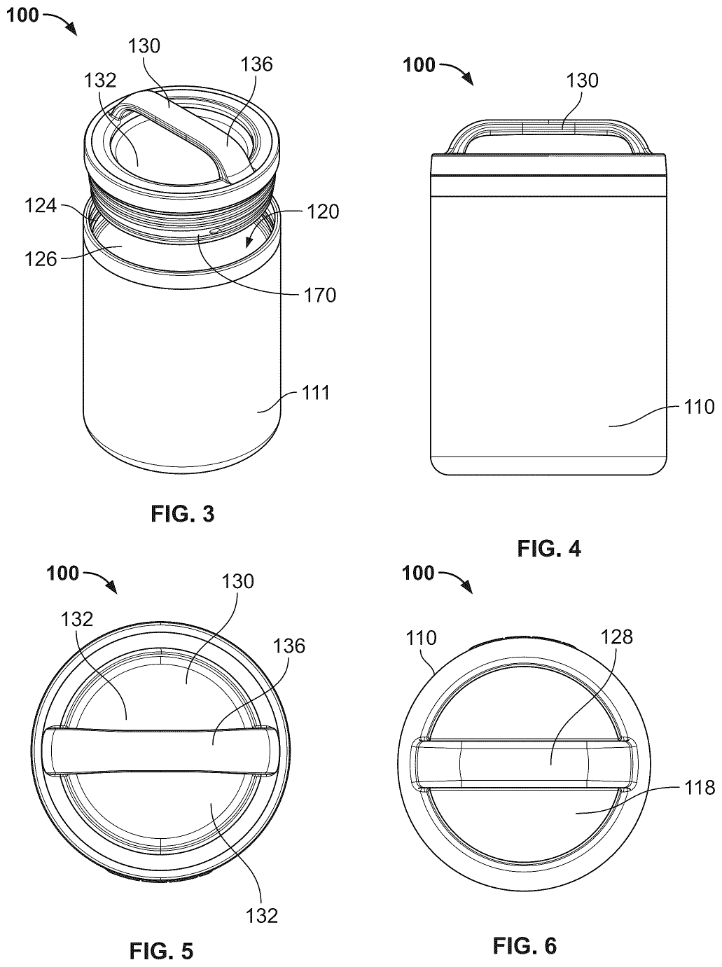

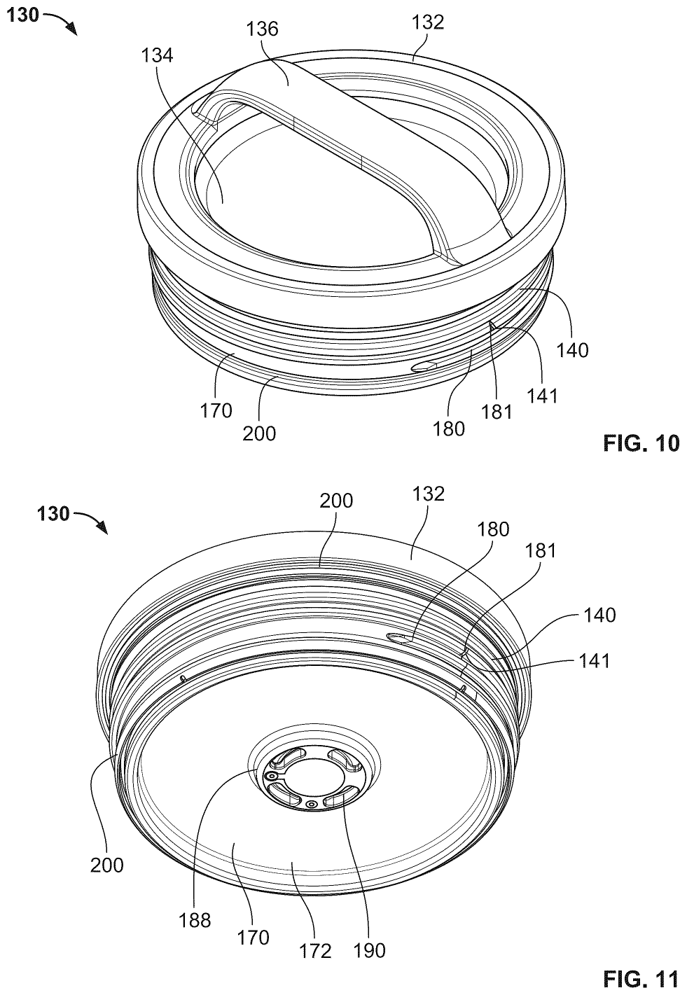

FIGS. 1-17 depict an exemplary container system 100. Container system 100 may comprise a container 110 and a lid assembly 130, where the lid assembly 130 is removably coupled to the container 110. The lid assembly 130 may seal a container opening 120 of the container 110 in an airtight and watertight manner, which may be referred to as a closed or sealed configuration. At times, pressure may build up within a sealed container due to various reasons, such as hot foods generating steam, spoiled food, or other reasons known to one skilled in the art. As pressure builds up within a storage compartment of a sealed container, the lid may become difficult to remove, for example, due to high frictional forces on threads. Container system 100 has a lid assembly 130 with an upper portion 132 and a lower portion 170 that during an opening operation provides a vent path 105 to allow gas to escape to reduce the pressure within a storage compartment 122 of the container 110 allowing the lid assembly 130 to be easily removed. The vent path 105 may be configured to allow air pressure in a storage compartment 122 of the container system 100 to equalize with ambient air pressure. For example, air may be allowed to vent or escape from inside of the storage compartment 122 to outside of the container system 100 through the vent path 105. The lid assembly 130 may be manually activated by a user to open the vent path 105 in the process of removing the lid assembly 130 from the container 110.

As best shown in FIGS. 1-6, the container system 100 may comprise a container 110 and a lid assembly 130. The container 110 may include a substantially cylindrical sidewall structure 111 having a top end 114 and a bottom end 116 with a bottom portion 118 connected to the bottom end 116. The bottom portion 118 is configured to support the container 110 on a surface. The container 110 may include a container opening 120 at the top end 114, where the container opening 120 leads to a storage compartment 122. A container engaging portion 124 may be located on an interior surface 126 of the sidewall structure 111 near the top end 114. In the illustrated example, the container engaging portion 124 may be an internal threaded portion or other means (e.g., bayonet connector) to removably couple the lid assembly 130 with the container 110. The lid assembly 130 may include an upper portion 132 and a lower portion 170. In some examples, the upper portion 132 may have a handle 136 that extends above a top wall 134 of the upper portion. In addition, the bottom portion 118 of the container 110 may include a recess or pocket 128 that is configured to receive a handle 136 from a second container system 100 to allow a plurality of container systems 100 to stack on top of each other. In some examples, the pocket 128 may also be employed by a user as a handle to generate torque to more easily rotate the lid assembly 130 to open or close the container system 100.

The lid assembly 130 may comprise an upper portion 132 and a lower portion 170 that are releasably connected. In addition, the upper portion 132 and the lower portion 170 may be moveably coupled when the upper portion 132 and the lower portion 170 are releasably connected such that the upper portion 132 may be able to rotate relative to the lower portion 170 and also move vertically relative to the lower portion 170. The lower portion 170 may be releasably connected to the upper portion 132 via a magnetic connection, where the upper portion 132 comprises an upper magnet 146 and the lower portion 170 comprises a lower magnet 194 such that a magnetic force between the upper magnet 146 and the lower magnet 194 releasably connect the upper portion 132 and the lower portion 170. However, the magnetic attraction between the upper magnet 146 and the lower magnet 194 still allows the upper portion 132 to move rotationally and vertically relative to the lower portion 170. In some cases, the magnetic connection may allow the lower portion 170 to be easily decoupled from the upper portion 132 for cleaning of the lid assembly 130. Alternatively, the upper portion 132 and the lower portion 170 may be releasably coupled using a mechanical fastener, a pin, or other means known to one skilled in the art.

The upper portion 132 may comprise a top wall 134 with a handle 136 extending above the top wall 134 where a bottom of the handle 136 may be spaced from a top surface of the top wall 134. The upper portion 132 may include a sidewall portion 138 extending below the top wall 134, where the sidewall portion 138 may include an upper engaging portion 140 to releasably engage the container engaging portion 124 of the container 110. The upper engaging portion 140 may comprise an external threaded portion. The lower portion 170 may have an outer surface 178 that includes a lower engaging portion 180, which may comprise an external threaded portion, that engages the container engaging portion 124 of the container 110. The upper engaging portion 140 may be longer than the lower engaging portion 180 (e.g., the external threaded portion of the upper portion 132 of the lid assembly 130 may be longer than the external threaded portion of the lower portion 170 of the lid assembly 130). The longer upper engaging portion 140 (e.g., threaded portion) when compared to the lower engaging portion 180 may inhibit separation of the upper and lower portions 132, 170 during removal where the upper portion 132 helps to transmit the torque to the lower portion 170 to unscrew the lower portion 170 from the container 110.

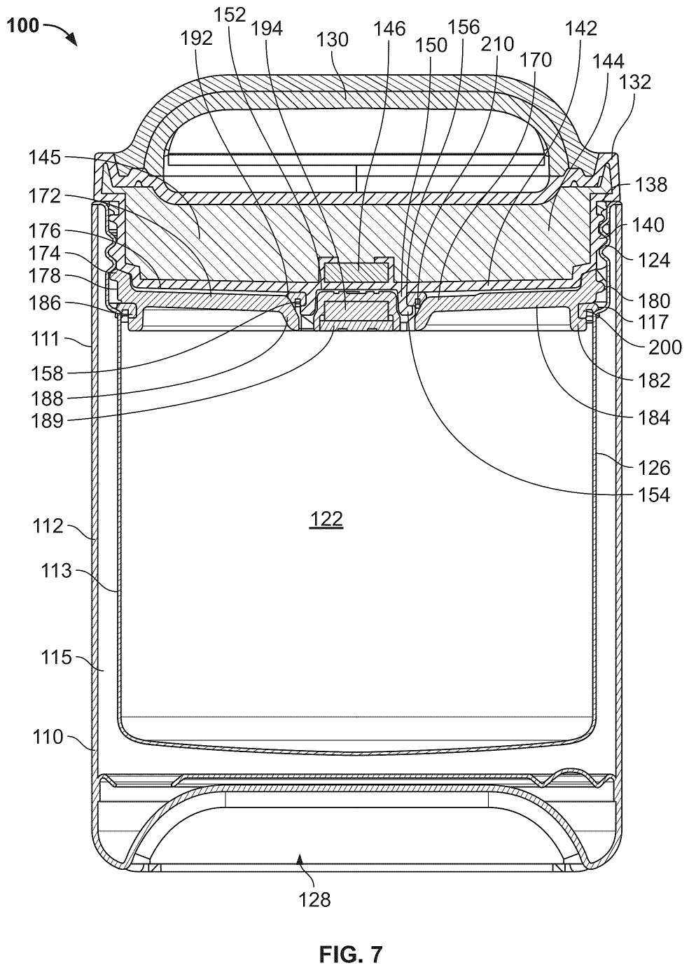

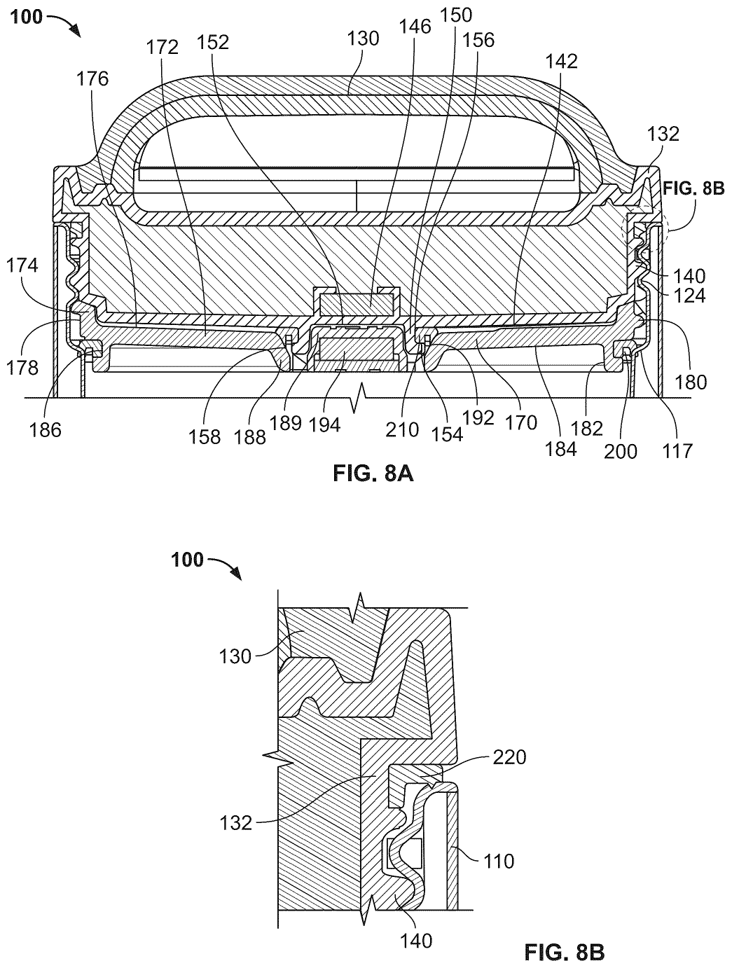

When the container system 100 is in the closed configuration as shown in FIGS. 7-8B, the lid assembly 130 forms an airtight and watertight seal with the container 110 via a lower gasket 200 that contacts and compresses against a shelf 117 of an interior surface 126 of the storage compartment 122, where the shelf 117 is located below the container engaging portion 124. The shelf 117 may act as a stop to prevent the lower portion 170 of the lid assembly 130 from moving below the shelf 117. In some embodiments, the shelf 117 may be optional, and the lower gasket 200 may compress against a vertical wall of the storage compartment 122 (e.g., inner sidewall 113). In addition, the upper portion 132 comprises a vent plug 150 that extends from a bottom wall 142. The vent plug 150 is configured to contact the lower portion 170 to seal the vent opening 190 when the container system 110 is in a closed configuration. The vent plug 150 may comprise a vent gasket 210 that is located around a perimeter of the vent plug 150 such that when the lid assembly 130 is fully engaged (e.g., the container system 100 is in the closed configuration) with the container 110, the vent gasket 210 contacts and compresses against the lower portion 170 to seal the vent opening or plurality of vent openings 190 that extend through the lower portion 170 to prevent air from escaping from the storage compartment 122 of the container 110. In some examples, the vent gasket 210 of the vent plug 150 may contact an upper surface 176 of the base 172 of the lower portion 170 to seal the vent opening 190. Additionally, the vent gasket 210 may contact an upper surface of a recess 192 that is formed in the upper surface 176 of the base 172. The contact between the vent gasket 210 of the vent plug 150 and the upper surface 176 of the base 172 may be located above the vent opening or plurality of vent openings 190. The upper portion 132 may also include an upper gasket 220 that helps seal the upper portion 132 to the container 110 near the top end 114. In some examples, the upper gasket 220 may include a vertical portion and a horizontal portion where the horizontal portion creates a face seal of the lid assembly 130 with the container 110 as shown in FIG. 8B. The horizontal portion may create a face seal which helps to prevent any ingress of fluids or outside elements into the container When the lid assembly 130 is being removed from the container 110, the movement of the upper portion 132 relative to the lower portion 170 of the lid assembly 130 may normalize any excess pressure that might have built up within the container system 100 by creating a vent path 105.

In some embodiments as shown in FIGS. 7-8B, in the closed configuration there may be a gap 173 between the upper surface 176 of the base 172 of the lower portion 170 and the bottom wall 142 of the upper portion 132. The gap 173 between the base 172 and the bottom wall 142 may ensure upward force is not transferred from the base to the upper portion 132. Rather, a lower engaging portion 180 may transfer any upward force (e.g., from internal pressure within the container system) to the container engaging portion 124 of the container 110. Accordingly, the reduction in force transferred to the upper portion 132 may reduce the friction on an upper engaging portion 140, thereby correspondingly reducing an opening torque used to open the lid assembly 130.

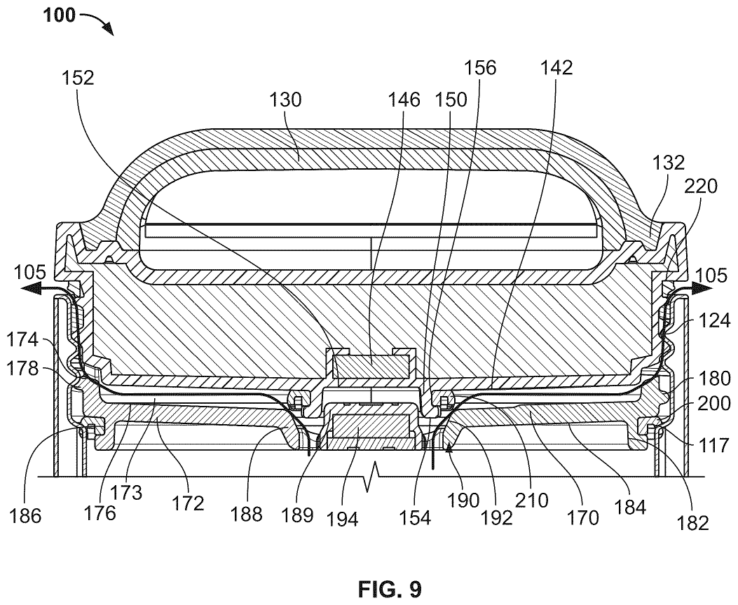

To remove the lid assembly 130, the upper portion 132 may be rotated a predetermined amount relative to the lower portion 170, the external threaded portion 140 of the upper portion 132 to move along the container engaging portion 124, which may be an internal threaded portion, of the container 110 while the lower portion 170 remains stationary. The lower portion 170 may remain stationary due in part to pressure within the storage compartment 122 that is resisted by the lower portion 170, thereby applying force to the lower engaging portion 180 (e.g., external threaded portion) of the lower portion 170 that generates stiction. As the upper portion 132 is unscrewed, the vent gasket 210 is moved away from the recess 192 of the lower portion 170 where the vent gasket 210 becomes free of contact with the lower portion 170. The container system 100 may be considered in an open configuration if the vent gasket 210 is free of contact with the lower portion 170. As shown in FIG. 9, when the vent gasket 210 is free of contact with the lower portion 170, a vent path 105 opens from the storage compartment 122 through the vent openings 190 and through the gaps within the threaded portions of the upper portion 132 and the container 110 to allow air to escape from the storage compartment 122 which reduces the internal pressure within the storage compartment 122, and also reduces the amount of effort required to remove the lid assembly 130. The reduction in internal pressure reduces the force applied to the lower engaging portion 180 (e.g., external threaded portion) of the lower portion 170, thereby reducing the stiction force between the lower engaging portion 180 and the container engaging portion 124 (e.g., internal threaded portion). By further rotating the upper portion 132 beyond the predetermined amount, the lower portion 170 then rotates with the upper portion 132 to allow the upper portion 132 and the lower portion 170 to move in unison to allow the lid assembly 130 to be fully unscrewed from the container 110.

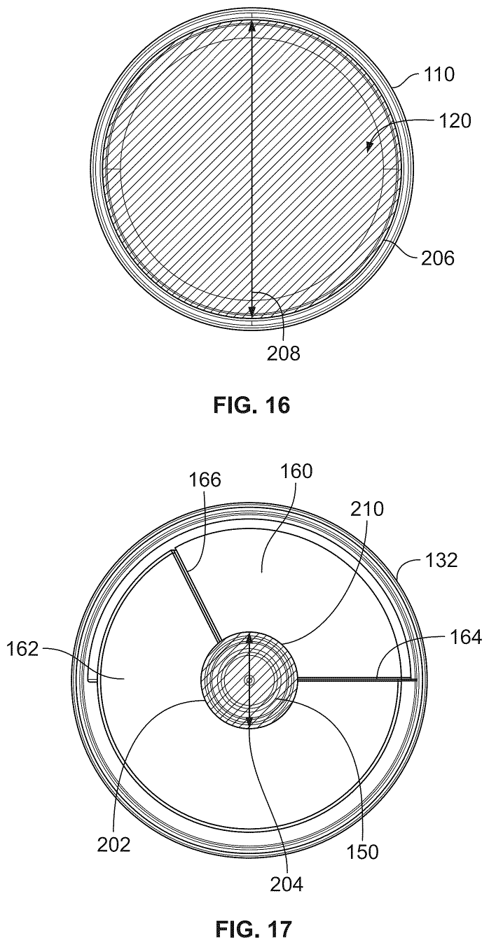

During removal of the lid assembly 130 from the container 110, the opening torque, which may be defined as the torque required by a user to start the lid assembly 130 moving in a removal direction, may be lower than a similar sized lid without a vent opening and a moveably coupled upper and lower portion. If food spoils, if a hot liquid cools within the storage compartment 122, or if gas is otherwise released from the contents (e.g., from carbonation), the internal pressure may increase, which may cause the opening torque to also increase. In some instances, as the pressure increases inside the storage compartment 122, the increased pressure causes a larger upward force on the lid assembly 130, which will increase the overall force on the engaging portions 124, 140, 180 (e.g., the threaded portions) that secure the lid assembly 130 to the container 110. This increased upward force may also increase the required opening torque. For removal of the lid assembly 130, the opening torque may be a function of the size or area 206 of the container opening 120 as shown in FIG. 16, the internal pressure within the storage compartment 122, and the size of the vent area 202 as shown in FIG. 16. The vent area 202 may be defined as an area of a bottom of the vent plug 150, which may comprise the contact area of the vent gasket 210 against the lower portion 170 as shown in FIG. 16. For example, if the vent gasket 210 has a generally circular shape with a diameter of 40 mm, the vent area 202 would be 1257 mm using the formula for the area of a circle. The size of the vent area 202 helps determine the effective upward force caused by the internal pressure within the storage compartment 122 that needs to be overcome by a user when trying to unscrew the lid assembly. The upward force generated by the internal pressure may be determined by the area over which the pressure is applied. Since the upward force applied to the vent area 202 is much less than the upward force applied to the area 206 of the container opening 120, the opening torque required to rotate the upper portion 132 relative to the lower portion 170 is reduced compared to a lid without a vent or movable upper and lower portions 132, 170. For example, a lid assembly 130 installed with a 2 Newton*meter (N*m) installation torque, may require an opening torque of less than 4 N*m when the lid assembly 130 has a vent area 202 of approximately 1700 mm² even when the internal pressure within the storage compartment 122 reaches approximately 15 psi. In some instances, the opening torque of lid assembly 130 may be expressed as a function of the pressure within the storage compartment 122. In particular, the opening torque, T, may be expressed as a function of the pressure as set forth in the equation, T≤0.4*P, where T is the opening torque in units of N*m and P is the pressure inside the storage compartment 122 in units of pounds per square inch (psi). The equation relates to a container system 100 when the pressure inside the storage compartment 122 is within a range of 8 psi to 30 psi and when the vent area 202 is within a range of 500 mm² and 1800 mm². The coefficient in the above equation (e.g., 0.4) may vary based on the material composition of the various engaging portions and their coefficients as friction, thread pitch, as well as other factors such as total opening area and a ratio between the vent area 202 and the total opening area. In some examples, an opening torque required to begin removing the lid assembly 130 from the container 110 may be less than or equal to 8 N*m when an internal pressure of the storage compartment 122 is within a range of 8 psi and 17 psi. To test the removal torque, the lid may be installed using a 2 N*m installation torque. The container system 100 is then pressurized to a predetermined pressure, such as 15 psi. The torque is then measured when the lid assembly 130 is removed. While the exemplary vent gasket 210 illustrates a circular shape, the vent gasket 210 is not limited to a circular shape. The vent gasket 210 may be square, rectangular, or other geometric shape.

In some cases, it may be desired to limit opening torque for a lid assembly 130 containing contents under pressure. In some embodiments, the opening torque may be less than or equal to 8 N*m, 6 N*m, or 4 N*m. These exemplary opening torque values may equate to a desired threshold torque that is able to provide reliable access to the contents of the storage compartment 122 of a container 110 for users having the strength of an average 5-year-old child. In some embodiments, the opening torque may be less than or equal to 15 N*m, 12 N*m, or 10 N*m. It is appreciated that these exemplary opening torque values may provide reliable access to the contents of the storage compartment 122 of a container 110 for users having the strength of an average adult. These opening torque values may be adhered to for exemplary embodiments herein when the container system 100 is subject to internal pressures up to 15 psi. The opening torques may be achieved in part by limiting the total vent area to ensure the force applied to an upper portion 132 of a lid assembly 130 is less than a threshold force that would cause the opening torque to be greater than a desired threshold torque. In some embodiments, the vent area may be less than or equal to 2000 mm². In other embodiments, the vent area may be less than or equal to 1500 mm². The opening torques may also be achieved in part by limiting a ratio of the vent area 202 to the total opening area 206 to ensure the force applied to an upper portion 132 of a lid assembly 130 is less than a threshold force that would cause the opening torque to be greater than a desired threshold torque. Such a ratio may ensure a lower portion 170 of a lid assembly 130 resists most of the pressure within the storage compartment 122 of the container system 100 such that the force on an upper portion 132 of a lid assembly 130 is limited.

The vent area 202 may be defined in terms of a ratio to the area of the container opening 120, which is the area at a top end 114 of the container 110. The ratio may be defined as the total opening area 206 of the container opening 120 divided by the vent area 202. In some examples, the ratio of the area 206 of the container opening 120 to the vent area 202 may be within a range of 100:1 and 3:1, or within a range of 20:1 and 3:1, or within a range of 18:1 and 4:1, or within a range of 14:1 and 6:1. Expressed as a percentage of total opening area, the vent area may be between 6% and 15%, or within a range of 1% and 33%. In some examples, the inventors have appreciated the benefits of a vent area of less than 20% of the total opening area, for example, between 1% and 15%. In some embodiments, the vent area may be less than or equal to 3.0% of the total opening area 206 of the container opening 120. In the illustrated examples, the vent gasket 210 may have a diameter 204 of approximately 33 mm, or within a range of 25 mm and 40 mm, or within a range of 19 mm and 47 mm. In addition, the exemplary container 110 of the container system 100 of FIGS. 1-17 may have a container opening 120 with a diameter 208 may be approximately 134 mm or within a range of 100 mm and 175 mm. Alternatively, the container 110 may have a diameter 208 greater than 175 mm or as discussed below, a diameter 208 less than 100 mm.

As discussed above, the lid assembly 130 may comprise an upper portion 132 and a lower portion 170 that are moveably coupled, where the upper portion 132 can rotate relative to the lower portion 170 and also move vertically relative to the lower portion 170. The upper portion 132 may have a top wall 134, a handle 136 spanning across the top wall 134, a sidewall portion 138 extending below the top wall 134 with an upper engaging portion 140, and a bottom wall 142 connected to the sidewall portion. The upper engaging portion 140, which may comprise an external threaded portion, may engage the container engaging portion 124. The upper portion 132 may have an interior cavity 144 that is at least partially enclosed by the top wall 134, the sidewall portion 138, and the bottom wall 142. The interior cavity 144 may also include an insulating portion 145. The insulation portion 145 may be a polymer foam, such as polystyrene or a foam insulation, or other insulation means known to one skilled in the art.

In addition, the upper portion 132 may also include an upper magnet 146 that is secured within the upper portion 132, where the upper magnet 146 may be secured within the interior cavity 144 of the upper portion 132. The upper magnet 146 may located along a longitudinal axis of the substantially cylindrical sidewall portion 138. A vent plug 150 may extend from and below the bottom wall 142, where the vent plug 150 has a receiver 152 in a lower surface 154. The receiver 152 may be a pocket or cavity that is recessed from the lower surface 154. A groove 156 may be located in an outer surface 158 of the vent plug 150. The vent gasket 210 may be received within the groove 156 on the vent plug 150.

The lower portion 170 may include a base 172, an upper lip 174 extending along a perimeter of an upper surface 176 of the base 172, and a lower lip 182 extending from a lower surface 184 of the base 172. The lower portion 170 may have an outer surface 178 that includes a lower engaging portion 180 that engages the container engaging portion 124 of the container 110. For instance, the lower engaging portion 180 may comprise an external threaded portion that engages the internal threaded portion 124 of the container 110. The lower lip 182 may include a groove 186 along a perimeter of the lower lip 182, where the groove 186 receives the lower gasket 200. A central protrusion 188 may extend from the lower surface 184 of the base 172, where the central protrusion 188 may have a vent opening or plurality of vent openings 190 that extend through the upper surface 176 and the lower surface 184 of the base 172. In the illustrated example, the plurality of vent openings 190 comprises four vent openings 190 that are arranged symmetrically a longitudinal axis of the lower portion 170. Each vent opening 190 of the plurality of vent openings 190 may be the same size, but in other examples, each vent opening 190 may be different sizes. Additionally, a recess 192 may be formed in the upper surface 176 of the base 172 that extends into the central protrusion 188, where the recess 192 may be ring-shaped around a projection 189. The lower magnet 194 may be located within the projection 189. As discussed above, a magnetic force between the upper magnet 146 and the lower magnet 194 may releasably connect the upper portion 132 and the lower portion 170.

As best shown in FIGS. 7-8, when the lid assembly 130 is engaged with the container 110, the upper portion 132 and the lower portion 170 may be arranged such that the vent plug 150 of the upper portion 132 is at least partially received within the recess 192 of the lower portion 170. In addition, the projection 189 is at least partially received within the receiver 152 of the vent plug 150 of the upper portion 132. The projection 189 and the receiver 152 may both be generally cylindrical in shape, such that the projection 189 may be able to rotate within the receiver 152. A diameter of the projection 189 may be smaller than a diameter of the receiver 152 of the vent plug 150. By receiving the projection 189 within the receiver 152, the upper magnet 146 and the lower magnet 194 may be in close proximity to each other. In some examples, a center of the magnets 146, 194 may be located and aligned along a longitudinal axis that is defined by the cylindrical sidewall portion 138 of the upper portion 132 and/or the upper lip 174 of the lower portion 170.

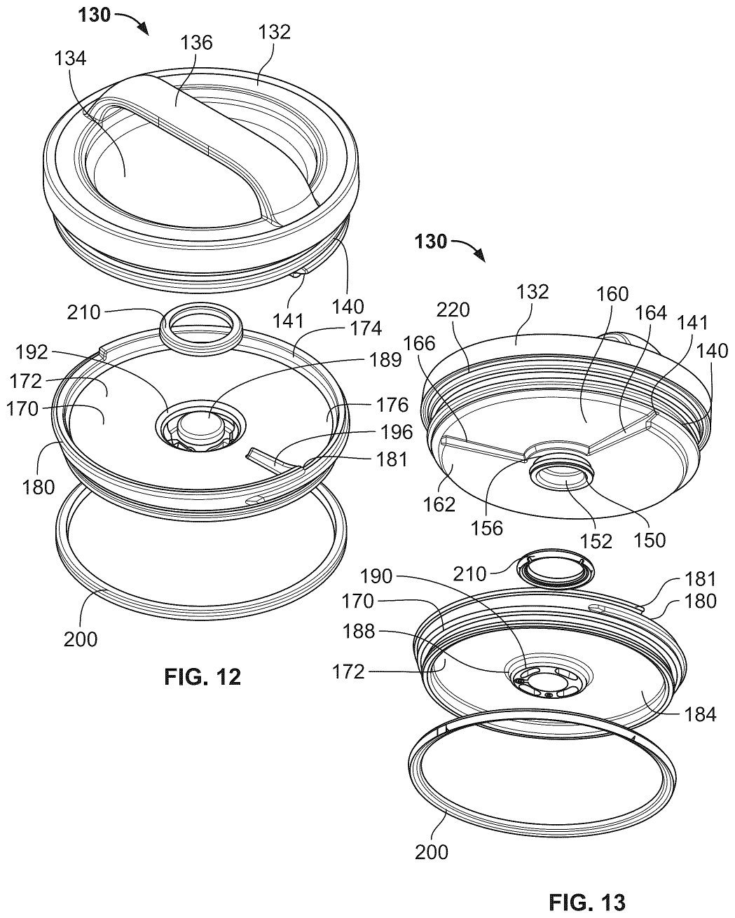

Additionally, the bottom wall 142 of the upper portion 132 may have features to interact with the lower portion 170. The bottom wall 142 may include a pocket 160 formed in a lower surface 162 of the bottom wall 142, where the pocket may 160 define a first step 164 extending linearly from the vent plug 150, and a second step 166 extending linearly from the vent plug 150. The first step 164 and the second step 166 may form stops to limit the rotation of the lower portion 170 relative to the upper portion 132. The pocket 160 may extend to the sidewall portion 138. In some examples, the first step 164 and the second step 166 may each be planar surfaces that converge toward each other. An angle may be formed between the first step 164 and the second step 166 of approximately 120 degrees or within a range of 90 degrees and 150 degrees, or within a range of 60 degrees and 180 degrees. In some examples, the angle between the first step 164 and the second step 166 may determine the predetermined amount the upper portion 132 rotates relative to the lower portion 170 that causes the vent gasket 210 to move away from the lower portion 170 to open the vent path 105. As shown in FIG. 12, a tab 196 located on the lower portion 170 may be configured to contact either the first step 164 or the second step 166 to limit the rotation of the upper portion 132 relative to the lower portion 170. The tab 196 may extend upward from the upper surface 176 of the base 172 and may also extend radially inward from the upper lip 174. When removing the lid assembly 130, once the upper portion 132 moves a predetermined amount, the tab 196 of the lower portion may contact the second step 166 of the upper portion 132 to allow the upper portion 132 and the lower portion 170 to move in unison to allow the lid assembly 130 to be fully unscrewed from the container 110.

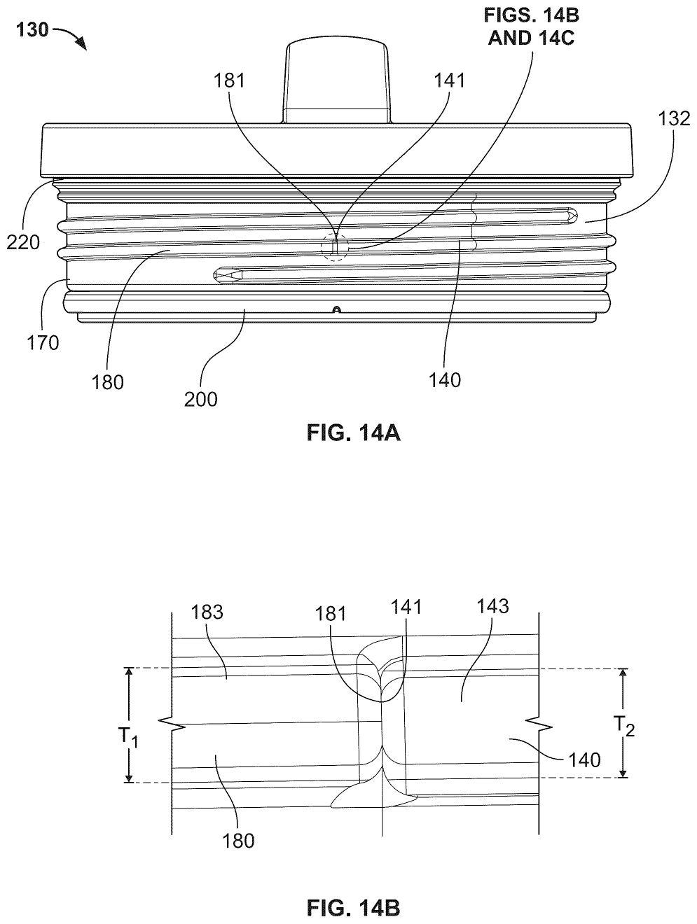

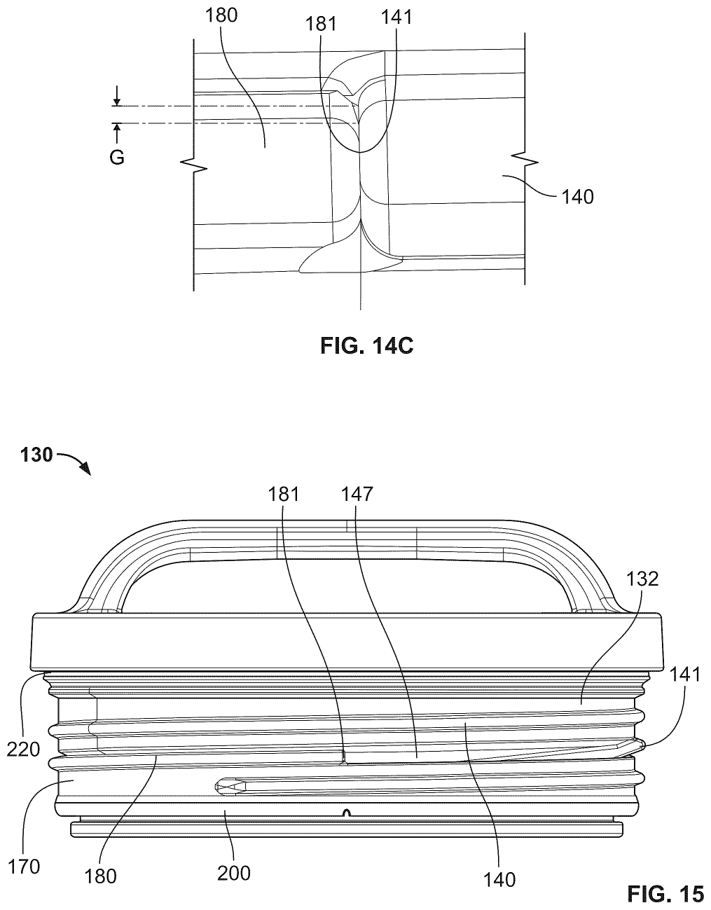

Both the upper engaging portion 140 of the upper portion 132 and the lower engaging portion 180 of the lower portion 170 may both comprise external threaded portions. The external threaded portions of both engaging portions 140, 180 when connected may form a single continuous thread that engages the internal threaded portion of the container 110. An end 141 of the external threaded portion (upper engaging portion 140) of the upper portion 132 may contact an end 181 of the external threaded portion (lower engaging portion 180) of the lower portion 170 as shown in FIG. 14A. The first step 164 may be substantially coplanar with the end 141 of the external threaded portion of the upper portion 132. When the lid assembly 130 is being screwed onto the container 110, the tab 196 may be in contact with the first step 164 (as well as the ends 141, 181 being in contact with each other) to allow the external threaded portions of both the upper portion 132 and the lower portion 170 seamlessly engage the internal threaded portion of the container 110 to tighten and seal the lid assembly 130 to the container 110.

In some examples, the external threaded portion of the engaging portion 180 of the lower portion 170 may have a thread profile 183 with a thickness, T1, that is greater than the thickness, T2, of the thread profile 143 of the external threaded portion of the engaging portion 140 of the upper portion 132 as shown in FIG. 14B. Even with the thicker thread profile 183, the external threaded portion of the engaging portion 180 may have the same pitch and form a continuous thread with the threaded portion of the engaging portion 140. The thread profile 183 may be within a range of 100 percent and 130 percent of the thickness of the thread profile 143. By having a larger thread profile 183, the threaded portion of the lower portion 170 allows for a more consistent removal torque because the threaded portion of the lower portion 170 receives any force caused by any pressure increase inside the storage compartment 122. Alternatively or additionally, the external threaded portion of the engaging portion 180 of the lower portion 170 may be offset from the external threaded portion of the engaging portion 140 by as distance, G, of the upper portion 132 as shown in FIG. 14C. The offset of the two threaded portions still allow the threaded portions to act as a continuous thread when screwing or unscrewing the lid assembly 130 from the container 110, however, the offset threaded portion of the engaging portion 180 allows for a more consistent removal torque because the threaded portion of the lower portion 170 receives any force caused by any pressure increase inside the storage compartment 122. The offset distance, G, may be within a range of 5 percent and 50 percent of thickness, T, of the thread profile of the external threaded portion of the engaging portion 180.

As discussed above, when a user is removing the lid assembly 130, the upper portion 132 may move relative to the lower portion 170 to allow the external threaded portion of the upper portion 132 to move along the internal threaded portion of the container 110 while the lower portion 170 remains stationary. As shown in FIG. 9, when the upper portion 132 is unscrewed relative to the lower portion 170 (e.g., the upper portion 132 is moved rotationally relative to the lower portion 170, and the upper portion 132 is also moved vertically upward away from the lower portion 170), the vent plug 150 and vent gasket 210 are moved away from the recess 192 of the lower portion 170 which opens a vent path 105 from the storage compartment 122 through the vent opening or vent openings 190 and through the gaps within the threaded portions 124, 140 of the upper portion 132 and the container 110 to allow air to escape from the storage compartment 122 to reduce any pressure buildup within the storage compartment 122. In addition, as shown in FIG. 15, when the upper portion 132 moves relative to the lower portion 170, the end 141 of the upper engaging portion 140 and the end 181 of the lower engaging portion may be separated where a gap 147 is formed between the two ends 141, 181 of the engaging portions 140, 180.

To clean the lid assembly 130, the lower portion 170 may be removed from the upper portion 132 by a user applying a force greater than the magnetic force between the upper magnet 146 and the lower magnet 194. Once the lower portion 170 and the upper portion 132 are separated, the two portions 132, 170 may be cleaned individually.

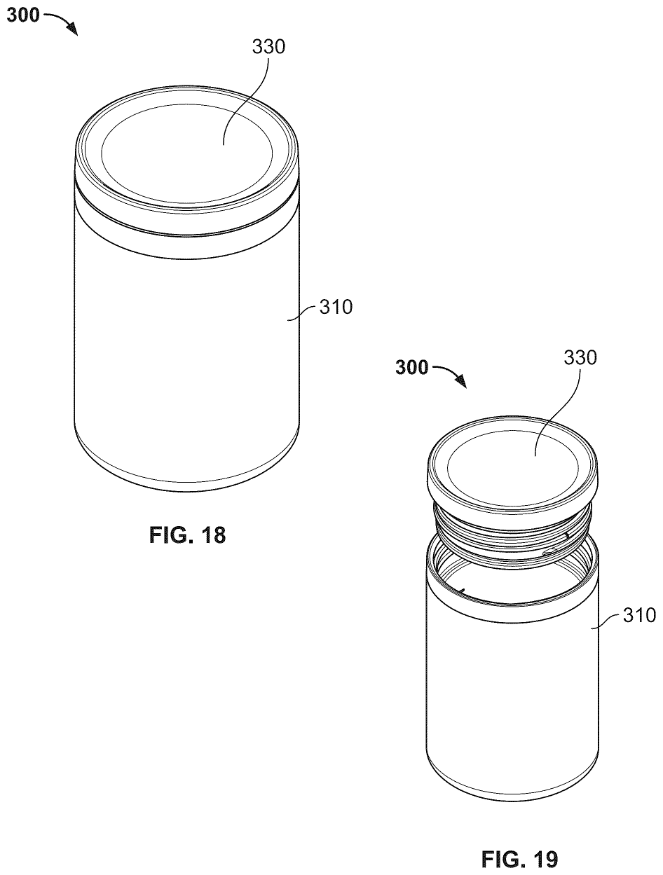

The container system 100 may be configured to store a volume of liquid or food in the storage compartment 122. In one example, the container system 100 may be configured to store approximately 40 ounces of a substance such as a liquid or food and in another implementation may be configured to store approximately 24 ounces of the substance. In other examples, the container system 100 may be configured to store at least approximately 8 ounces, at least approximately 16 ounces, at least approximately 24 ounces, ounces, at least approximately 80 ounces, or at least approximately 100 ounces. FIGS. 18-19 illustrate container system 300 which may have a smaller size than the illustrated example of FIGS. 1-17. However, container system 300 may have all of the same features as container system 100 with the only exception being the lid assembly 330 may not have a handle. The container 310 may have a smaller height or width (diameter 208) than container 110. For instance, the exemplary container 310 of the container system 300 of FIGS. 18-19 may have a container opening 320 with a diameter 208 may be approximately 83 mm or within a range of 50 mm and 120 mm.

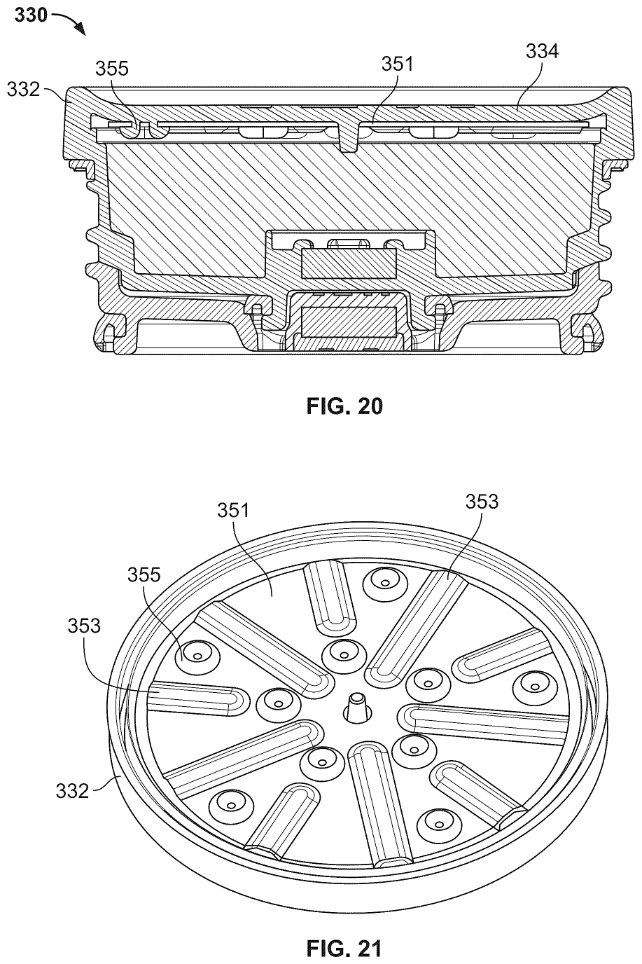

FIG. 20 illustrates a cross-sectional view of an alternate example of lid assembly 330 that has an internal stiffener 351 positioned under the top wall 334 of the upper portion 332 of the lid assembly 330. The internal stiffener 351 may be formed from a material with a higher stiffness than the material of the top wall 334. For instance, the internal stiffener 351 may be formed of a metallic material such as aluminum alloy, stainless steel alloy, titanium alloy, or carbon fiber composite. The stiffener 351 may further include a plurality of ribs 353 or raised regions to further increase the stiffness as shown in FIG. 21. The ribs 353 may be oriented in a radially direction. The stiffener 351 may be formed using a stamping or forming operation such that the stiffener has a constant wall thickness. The stiffener 351 may be permanently connected to top wall 334. In some examples, the stiffener 351 may be connected using heat or thermal staking of bosses 355 in multiple locations to secure the stiffener 351 to the top wall 334 of the upper portion 332. The stiffener 351 may have openings that receive the bosses 355 prior to the bosses 355 being thermal staked. The additional stiffness provided by the stiffener 351 may help improve durability of the lid assembly 330 when exposed to heat, such as being in a dishwasher that can bring an internal pressure of 5 psi and temperatures of 90° C., or when being dropped. While the illustrated example shown is of lid assembly 330, the stiffener 351 may be present in any of the lid assemblies disclosed herein.

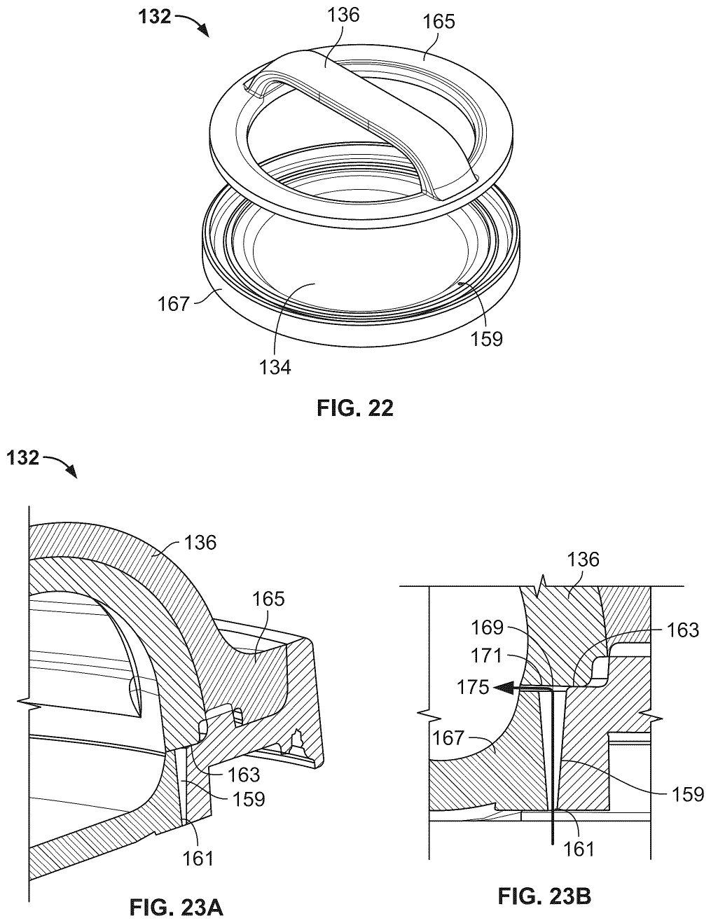

As another option for the lid assembly 130, the upper portion 132 may include a vent 159 underneath the handle 136 as shown in FIGS. 22-23B. The vent 159 may extend through an interior surface of an upper body 167 of the upper portion 132 with a vent pathway to outside of the lid assembly 130. The upper body 167 may include the top wall 134. The vent 159 may comprise a lower opening 161 on an interior surface of the top wall 134 and an upper opening 163 on an upper surface positioned beneath a portion of the handle 136. The lower opening 161 may be smaller than the upper opening 163 with a tapered or conical surface extending between the lower opening 161 and the upper opening 163. The handle 136 may be formed separately with a lower ring 165 that is permanently connected to the upper body 167 of the upper portion 132 using a friction welding process (e.g., spin welding) to permanently join the handle 136 as part of the upper portion 132. Once the handle 136 is connected, a small gap 171 may be present under the handle to allow air to pass to the vent 159 via the vent path 175. In some examples, a hydrophobic film 169 or membrane. The hydrophobic film 169 may help repel moisture from entering the vent 159 but still allow for air or gas to flow through the vent 159. The hydrophobic film 169 may secured to the upper body 167 using heat or thermal staking process, using an adhesive, or other means known to one skilled in the art. The additional venting provided by the vent 159 may help improve durability of the lid assembly 330 when exposed to heat, such as being in a dishwasher, or within a hot vehicle.

In some examples, container system 100 (or insulating container) may include one or more insulating elements configured to reduce a rate of heat transfer to or from a material stored within the container 110. In one example, the container 110 may be configured with a vacuum-sealed insulating structure, otherwise referred to as a vacuum-sealed double wall structure, or an insulated double wall structure. In such an example, the cylindrical sidewall structure 111 may comprise a sidewall structure with an outer sidewall 112 and an inner sidewall 113 that may be sealed such that a vacuum is maintained between the inner sidewall 113 and an outer sidewall 112 of the container 110. A sealed cavity 115 may be sandwiched between the inner sidewall 113 and the outer sidewall 112. The sealed cavity 115 may be a vacuum cavity in some examples. As shown in the cross-sectional view of FIG. 7, the sealed cavity 115 may extend between the sidewalls 112, 113 and also within the bottom portion such that the sealed cavity 115 is around all sides and below the storage compartment 122 of the container 110. In some examples, the combination of the inner sidewall 113 and the outer sidewall 112 may be referred to as an insulated wall. In one implementation, the top end 114, the bottom end 116, and/or sidewall structure 111 may comprise a vacuum-sealed insulated wall between the inner sidewall 113 and the outer sidewall 112. The inner sidewall 113 may form a sidewall of the storage compartment 122 and the outer sidewall 112 may form the exterior sidewall of the container 110. The majority of the inner sidewall 113 of the container 110 may be cylindrical such that the storage compartment 122 has a constant diameter. In some examples, the interior surface 126 of the sidewall structure 111 may have a ceramic coating. Additionally, the diameter (e.g., maximum width) across at the top end 114 the container opening 120 may be greater than the diameter (e.g., maximum width) across the storage compartment 122 located below the container engaging portion 124.

The container 110 may be constructed from one or more metals, alloys, polymers, ceramics, or fiber-reinforced materials. Additionally, container 110 may be constructed using one or more hot or cold working processes (e.g. stamping, casting, molding, drilling, grinding, forging, among others). In one implementation, the container 110 may be constructed using a stainless steel. One or more cold working processes may be utilized to form the geometry of the container 110 may result in the container 110 being magnetic.

In some examples, the container 110 may be embodied with different geometries. For example, container system 100 may be embodied with container, similar to container 110, having a non-cylindrical shape. In particular, container may have a substantially cuboidal, conical, spherical, or prismoidal shape, or combinations thereof, among others, without departing from the scope of the disclosures described herein. As such, container system 100 may have a container 110, having a non-cylindrical shape, but maintaining a substantially cylindrical upper portion that may be removably coupled to the lid assembly 130.

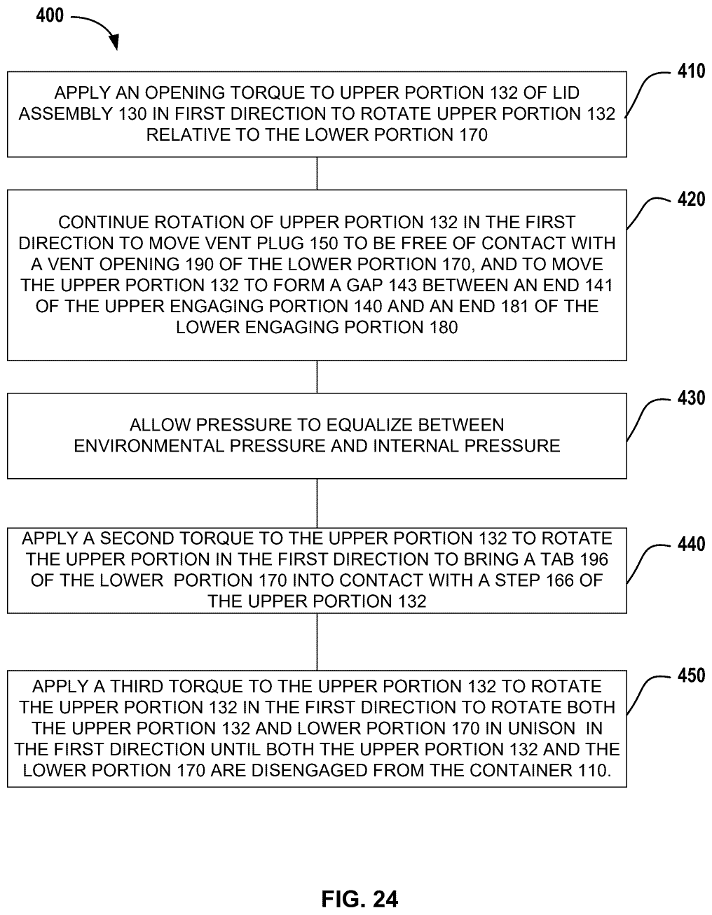

FIG. 24 illustrates a flowchart for a method 400 for removing the lid assembly 130 from the container 110 to move the container system 100 from a closed configuration to an open configuration to allow access to the storage compartment 122. First, a user may apply an opening torque in a first direction to the upper portion 132 of the lid assembly 130. For example, a user may grasp the handle 136 or other part of the upper portion 132 and apply an opening torque (e.g., a first torque) to cause the upper portion 132 to rotate relative to the lower portion 170 (410). As the upper portion 132 is rotated in the first direction, the upper portion 132 moves away from the lower portion 170 (420), which moves the vent plug 150 away from the lower portion 170. In addition, as shown in FIG. 15, as the upper portion 132 rotates relative to the lower portion 170, a gap 147 forms between an end 141 of the upper engaging portion 140 and an end 181 of the lower engaging portion 180. When the vent plug 150 is free of contact with a vent opening 190 of the lower portion 170, pressure is allowed to equalize between the environmental pressure and internal pressure as air escapes through the vent opening 190 (430). Once the pressure equalizes, the torque required to be applied will be reduced, as the user applies this second torque to the upper portion 132, the upper portion 132 rotates in the first direction to bring a tab 196 of the lower portion 170 to contact with a step 166 formed on the upper portion 132 (440). When the tab 196 and the step 166 are in contact with each other, the torque required to move the lid assembly 130 may increase compared to the second torque as the upper portion 132 and the lower portion 170 move in unison so as the third torque is applied in the first direction to the upper portion 132, the upper portion 132 and the lower portion 170 both rotate and move upward guided by the interaction of the engaging portions 140, 180 with the container engaging portion 124. The third torque is applied until the lid assembly 130, both the upper portion 132 and the lower portion 170 are disengaged from the container 110 (450). While the method 400 refers to the container system 100 illustrated in FIGS. 1-17, the method 400 applies to the container system 300 shown in FIGS. 18-19.

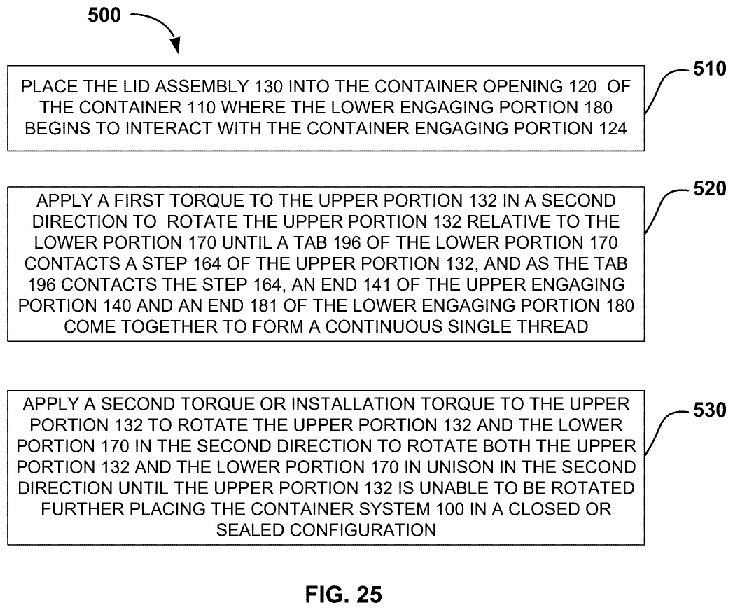

FIG. 25 illustrates a flowchart for a method 500 for installing the lid assembly 130 to the container 110 to move the container system 100 from an open configuration to a closed configuration to prevent access to the storage compartment 122. A user may place the lid assembly 130 into the container opening 120 of the container 110 where the lower engaging portion 180 begins to interact with the container engaging portion 124 and where the lid assembly 130 comprises the upper portion 132 and the lower portion 170 are releasably coupled (510). Next, the user may apply a first torque to the upper portion 132 in a second direction, which is opposite the first direction used to remove the lid assembly 130. As the first torque is applied to the upper portion 132, the upper portion 132 may rotate relative to the lower portion 170 until a tab 196 of the lower portion 170 contacts a step 164 of the upper portion 132. As the tab 196 contacts the step 164, an end 141 of the upper engaging portion 140 and an end 181 of the lower engaging portion 180 come together to form a continuous single thread (520). As the first torque is applied, a vent plug 150 of the upper portion 132 may be brought into contact with a vent opening 190 of the lower portion 170. Next, a second torque (e.g., an installation torque, which may be greater than the first torque, may be applied to the upper portion 132 to rotate the upper portion 132 and the lower portion 170 in the second direction to rotate both the upper portion 132 and the lower portion 170 in unison in the second direction until the upper portion 132 is unable to be rotated further placing the container system 100 in a closed or sealed configuration (530).

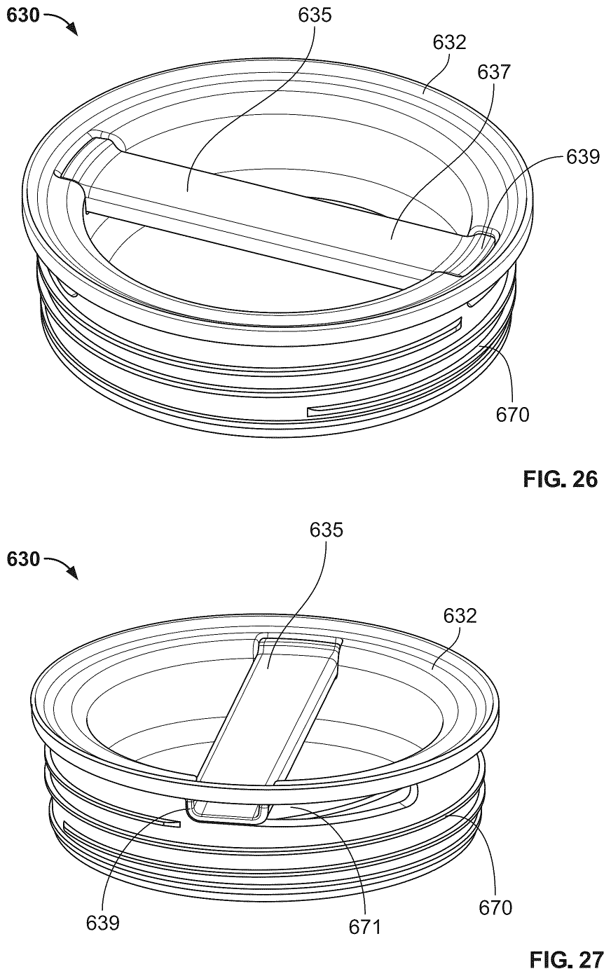

For the lid assembly 630 of FIGS. 26-27, the features are referred to using similar reference numerals under the “6xx” series of reference numerals, rather than “1xx” as used in the lid assembly 130 of FIGS. 1-17. Accordingly, certain features of the lid assembly 630 that were already described above with respect to lid assembly 130 of FIGS. 1-17 may be described in lesser detail, or may not be described at all. Lid assembly 630 may comprise an upper portion 632 and a lower portion 670 that are moveably coupled, where the upper portion 632 can rotate relative to the lower portion 670 and also move vertically relative to the lower portion 670. As an alternative or addition to the magnetic coupling of the lid assembly 130, the upper portion 632 and the lower portion 670 may be mechanically coupled using a removable handle 635. Lid assembly 630 may include a handle 635 that removably engages the upper portion 632 and the lower portion 670 and also movably couples the upper portion 632 with the lower portion 670. The upper portion 632 may have an upper engaging portion (e.g., an external threaded portion) that engages a corresponding engaging portion (e.g., an internal threaded portion) on an interior surface of the lower portion 670 such that the upper portion 832 may be at least partially received within a cavity on an upper region of the lower portion 670.

When connected to the lid assembly 630, the handle 635 may be non-movably coupled to the upper portion 632 and also movably coupled to the lower portion 670. The handle 635 may have an elongated body 637 with a hook 641 on each end 639. Each hook 641 may be inserted into an opening 633 on the upper portion 632, where the opening 633 may comprise a pair of openings 633 arranged on opposite sides of the upper portion 632. Each hook 641 may also extend into a slot 671 located on the lower portion 670, where a slot 671 is arranged on opposite sides of the lower portion 670. Each hook 641 may have a lower section that extends into the opening 633 of the upper portion 632 and also extends into a slot 671 located on the lower portion 670. In particular, the hook 641 may be moveably engaged within the slot 671 of the lower portion. This movable coupling of the hook 641 with the lower portion 670 allows the upper portion 632 to be rotated relative to the lower portion 670 while keeping the upper portion 632 and the lower portion 670 coupled together. When installed the handle 635 may prevent the upper portion 632 from separating from the lower portion 670. The handle 635 may mechanically couple the upper portion 632 and the lower portion 670 together. When the handle 635 is removed from the upper portion 632, the lower portion 670 may be removed from the upper portion 632 to allow for cleaning of the lid assembly 630. Similar to lid assembly 130, a user can release any pressure buildup within the container 110 by rotating the upper portion 632 relative to the lower portion 670.

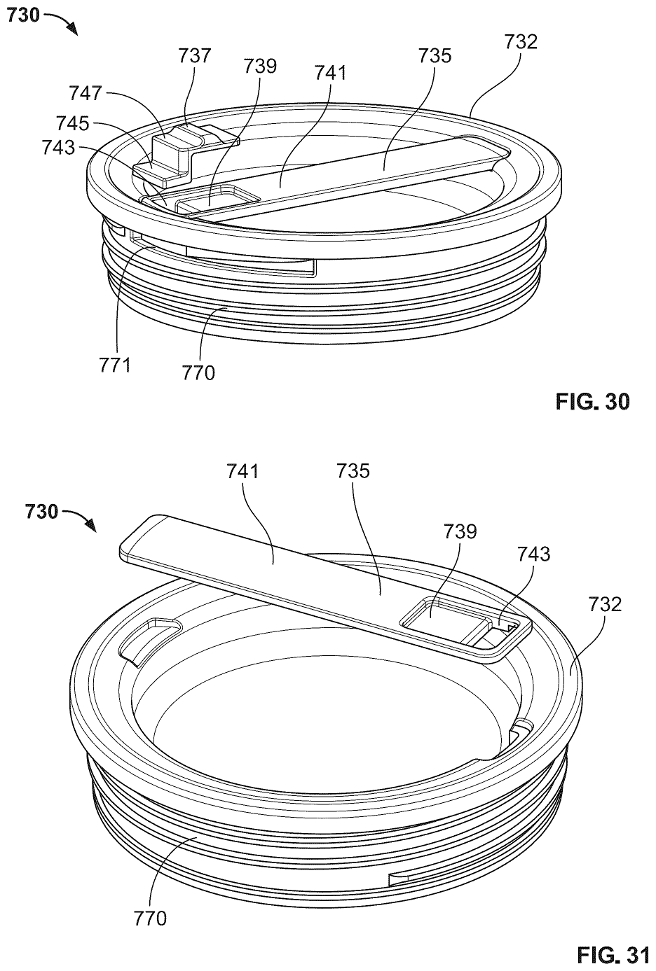

For the lid assembly 730 of FIGS. 29-31, the features are referred to using similar reference numerals under the “7xx” series of reference numerals, rather than “1xx” as used in the lid assembly 130 of FIGS. 1-17. Accordingly, certain features of the lid assembly 730 that were already described above with respect to lid assembly 130 of FIGS. 1-17 may be described in lesser detail, or may not be described at all. Lid assembly 730 may comprise an upper portion 732 and a lower portion 770 that are moveably coupled, where the upper portion 732 can rotate relative to the lower portion 770 and also move vertically relative to the lower portion 770. As an alternative to or in addition to the magnetic coupling of the lid assembly 130, the upper portion 732 and the lower portion 770 may be mechanically coupled using a movable slider 737 on the handle 735 such that the slider can selectively engage a slot 771 on the lower portion 770. The upper portion 732 may have an upper engaging portion (e.g., an external threaded portion) that engages a corresponding engaging portion (e.g., an internal threaded portion) on an interior surface of the lower portion 770 such that the upper portion 732 may be at least partially received within a cavity on an upper region of the lower portion 770.

The slider 737 may move between an engaged or locked position and a disengaged or unlocked position. The slider 737 may slidably move in a track or cavity 739 located on an upper surface 741 of the handle 735. The handle 735 may have an opening 743 within the cavity 739 that receives a locking tab 745 of the slider 737. The locking tab 745 extends outward beneath an upper surface 747 of the slider 737. As the slider 737 is moved outward, the slider 737 is in an engaged or locked position. When in an engaged or a locked position, the locking tab 745 is inserted into a slot 771 located on the lower portion 770 to allow the upper portion 732 to rotate relative to the lower portion 770. The locking tab 745 is slidably engaged with the slot 771 when the slider 737 is in a locked position. In addition, when the slider 737 is in the locked position, the upper portion 732 is coupled to the lower portion 770 such that the upper portion 732 and the lower portion 770 cannot be separated. However, when the slider 737 is in the unlocked position, the upper portion 732 and the lower portion 770 may be separated. Similar to lid assembly 130, a user can release any pressure buildup within the container 110 by rotating the upper portion 732 relative to the lower portion 770.

The handle 735 may include a pair of magnetic elements spaced apart from each other that are either embedded within the handle 735 or located on a bottom surface (opposite the upper surface of the handle 735. The slider 737 may include a magnetic element such that the magnetic element in the slider magnetically couples to a first magnetic element of the pair of the magnetic elements of the handle 735 when the slider 737 is in an unlocked position and magnetically couples to a second magnetic element of the pair of magnetic elements when the slider 737 is in a locked position. Thus, the magnetic attraction between the magnetic element of the slider 737 and the magnetic elements of the handle 735 prevents the slider 737 from moving until a user moves the slider from either a locked position to an unlocked position or an unlocked position to a locked position.

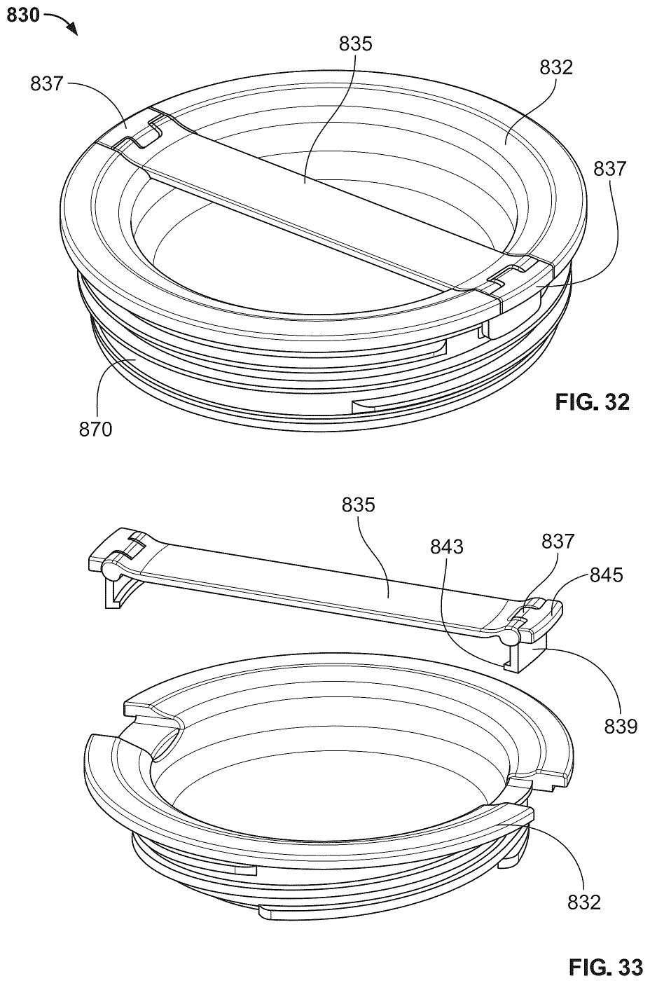

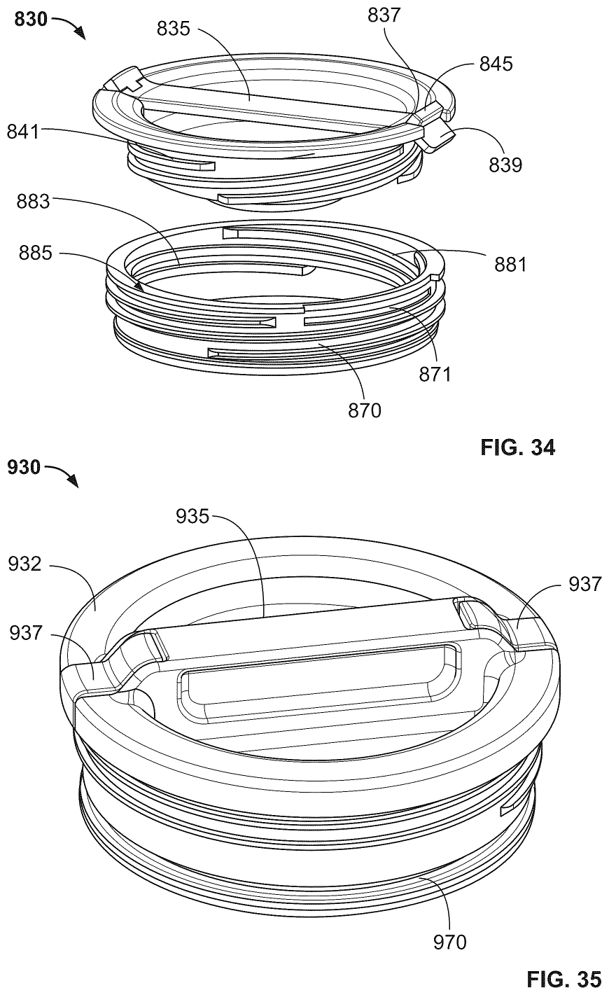

For the lid assembly 830 of FIGS. 32-34, the features are referred to using similar reference numerals under the “8xx” series of reference numerals, rather than “1xx” as used in the lid assembly 130 of FIGS. 1-17. Accordingly, certain features of the lid assembly 830 that were already described above with respect to lid assembly 130 of FIGS. 1-17 may be described in lesser detail, or may not be described at all. Lid assembly 830 may comprise an upper portion 832 and a lower portion 870 that are moveably coupled, where the upper portion 832 can rotate relative to the lower portion 870 and also move vertically relative to the lower portion 870. As an alternative to or in addition to the magnetic coupling of the lid assembly 130, the upper portion 832 and the lower portion 870 may be mechanically coupled using a latch 837 or pair of latches 837 that are arranged at on an end or both ends of the handle 835, where the handle 835 is fixedly attached to the upper portion 832. The upper portion 832 may have an upper engaging portion 841 (e.g., an external threaded portion) that engages a corresponding engaging portion 881 (e.g., an internal threaded portion) on an interior surface 883 of the lower portion 870 such that the upper portion 832 may be at least partially received within a cavity 885 on an upper region of the lower portion 870.

Each latch 837 may be pivotally connected to the handle 835 such that the latch 837 may have a locked position and an unlocked position. Each latch 837 may comprise a hook 839 that engages a track 871 on an outer surface of the lower portion 870 when the latch 837 is in a locked position. The hook 839 may extend downward from the upper surface of the latch 837, where the hook 839 comprises an inward extending tab 845 that engages the track 871. When the hook 839 is engaged with the track 871, the hook 839 limits the amount the upper portion 832 can rotate relative to the lower portion 870. In addition, when the latch 837 is in the locked position, the upper portion 832 is coupled to the lower portion 870 such that the upper portion 832 and the lower portion 870 cannot be separated. To move the latch 837 to the unlocked position, a user rotates the latch 837 upward by applying an upward force on the release extension 847, which disengages the hook 839 from the track 871. When the latch 837 is in the unlocked position, the upper portion 832 and the lower portion 870 may be separated. Similar to lid assembly 130, a user can release any pressure buildup within the container 110 by rotating the upper portion 832 relative to the lower portion 870.

For the lid assembly 930 of FIGS. 35-37, the features are referred to using similar reference numerals under the “9xx” series of reference numerals, rather than “1xx” as used in the lid assembly 130 of FIGS. 1-17. Accordingly, certain features of the lid assembly 930 that were already described above with respect to lid assembly 130 of FIGS. 1-17 may be described in lesser detail, or may not be described at all. Lid assembly 930 may comprise an upper portion 932 and a lower portion 970 that are moveably coupled, where the upper portion 932 can rotate relative to the lower portion 970 and also move vertically relative to the lower portion 970. As an alternative to or in addition to the magnetic coupling of the lid assembly 130, the upper portion 932 and the lower portion 970 may be mechanically coupled using a latch 937 or pair of latches 937 that are arranged at on an end or both ends of the handle 935, where the handle 935 may be integrally formed with the upper portion 932. The upper portion 932 may have an upper engaging portion 941 (e.g., an external threaded portion) that engages a corresponding engaging portion 981 (e.g., an internal threaded portion) on an interior surface 983 of the lower portion 970 such that the upper portion 932 may be at least partially received within a cavity 985 on an upper region of the lower portion 970.

As shown in FIG. 37, the handle 935 may have a hollow portion 941 that may be filled with an insulating portion similar to that described above. Each latch 937 may be pivotally connected to the handle 935 such that the latch may have a locked position and an unlocked position. Each latch 937 may comprise a hook that engages a track 971 on an outer surface of the lower portion 970 when the latch 937 is in a locked position. The hook may be similar to the hook 839 of the latch 837 described above. The hook may extend downward from the upper surface of the latch 937, where the hook comprises an inward extending tab that engages the track 971. When the hook is engaged with the track 971, the hook limits the amount the upper portion 932 can rotate relative to the lower portion 970. The track 971 may include a slot 973 that extends upward to the upper end of the lower portion 970. When installing the upper portion 932 onto the lower portion 970, the latch 937 is aligned with the slot 973 and then rotated to such that the hook engages the track 971. As the hook engages the track 971, the latch 937 automatically closes and moves to the locked position. When the latch 937 is in the locked position, the upper portion 932 is coupled to the lower portion 970 such that the upper portion 932 and the lower portion 970 cannot be separated. To move the latch 937 to the unlocked position, a user rotates the upper portion 932 to where the latch 937 aligns with the slot 973, which disengages the hook 939 from the track 971. When the latch 937 is in the unlocked position, the upper portion 932 and the lower portion 970 may be separated. Similar to lid assembly 130, a user can release any pressure buildup within the container 110 by rotating the upper portion 932 relative to the lower portion 970.

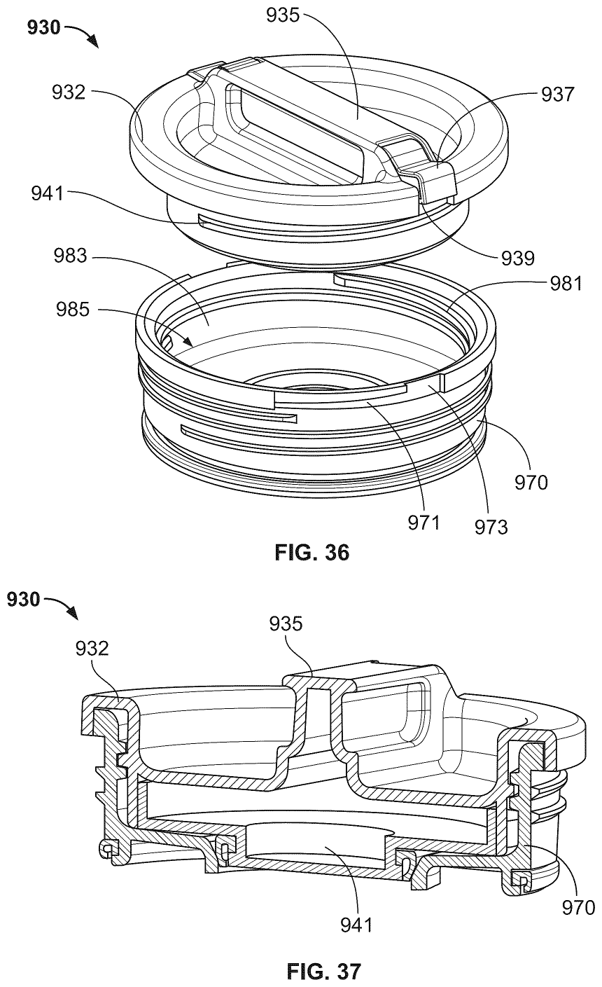

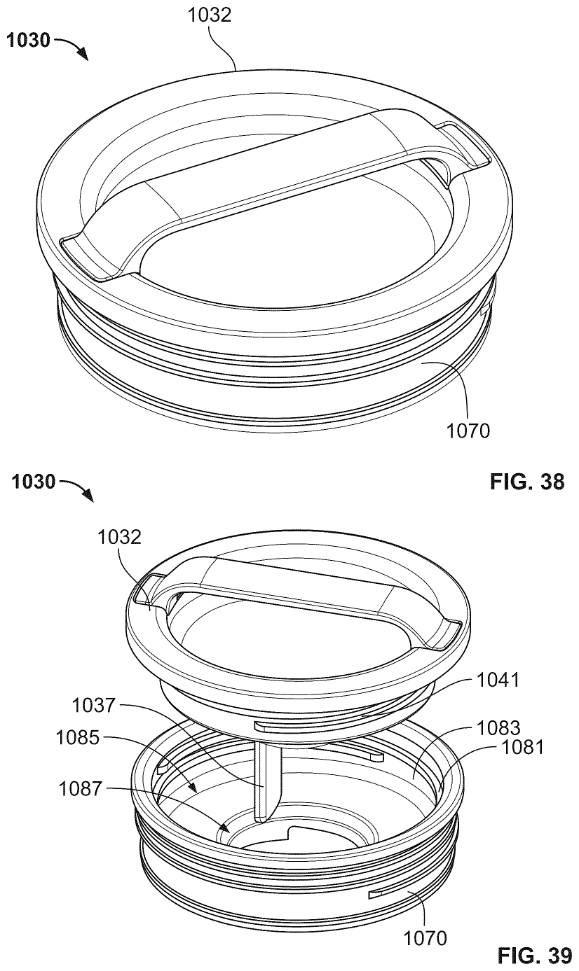

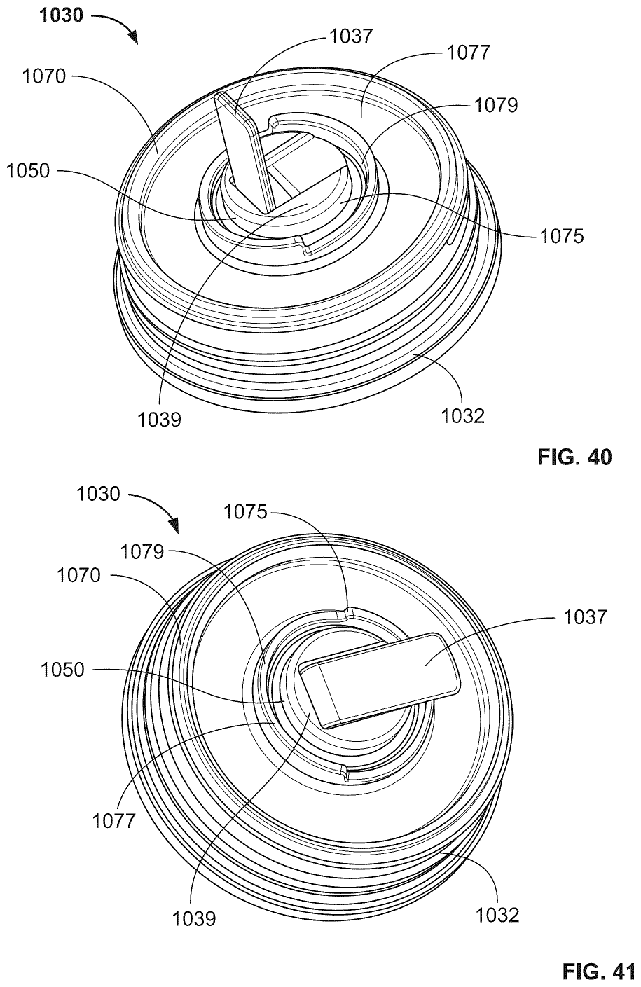

For the lid assembly 1030 of FIGS. 38-41, the features are referred to using similar reference numerals under the “10xx” series of reference numerals, rather than “1xx” as used in the lid assembly 130 of FIGS. embodiment of FIGS. 1-17. Accordingly, certain features of the lid assembly 1030 that were already described above with respect to lid assembly 130 of FIGS. 1-17 may be described in lesser detail, or may not be described at all. Lid assembly 1030 may comprise an upper portion 1032 and a lower portion 1070 that are moveably coupled, where the upper portion 1032 can rotate relative to the lower portion 1070 and also move vertically relative to the lower portion 1070. As an alternative to or in addition to the magnetic coupling of the lid assembly 130, the upper portion 1032 and the lower portion 1070 may be mechanically coupled using a lever 1037 that extends from a bottom surface 1039 of the vent plug 1050 of the upper portion 1032. The upper portion 1032 may have an upper engaging portion 1041 (e.g., an external threaded portion) that engages a corresponding engaging portion 1081 (e.g., an internal threaded portion) on an interior surface 1083 of the lower portion 1070 such that the upper portion 1032 may be at least partially received within a cavity 1085 on an upper region of the lower portion 1070. When the upper portion 1032 is at least partially received within the cavity 1085, the vent plug 1050 along with the lever 1037 extends through an opening 1087 of the lower portion 1070 as shown in FIG. 36. The lever 1037 may be pivotally connected to the vent plug 1050. The lever 1037 may have a locked position and an unlocked position. When in the locked position, the lever 1037 is rotated to a substantially horizontal position as shown in FIG. 37, where the lever 1037 contacts a lower surface 1077 of the lower portion 1070 to prevent the upper portion 1032 from being separated from the lower portion 1070. The lower surface 1077 may have a tapered portion 1079 (i.e., have a height that decreases or increases) and a stop 1075. The tapered portion 1079 allows for some rotational movement between the upper portion 1032 and the lower portion 1070 to allow a user to release any pressure buildup within the container 110 by rotating the upper portion 1032 relative to the lower portion 1070. As the upper portion 1032 is rotated, the lever 1037 will contact the stop 1075 to limit the amount of rotation between the upper portion 1032 and the lower portion 1070. To move the lever 1037 to the unlocked position, a user rotates the lever 1037 to the vertical orientation. This allows a user to remove the upper portion 1032 from the lower portion 1070.

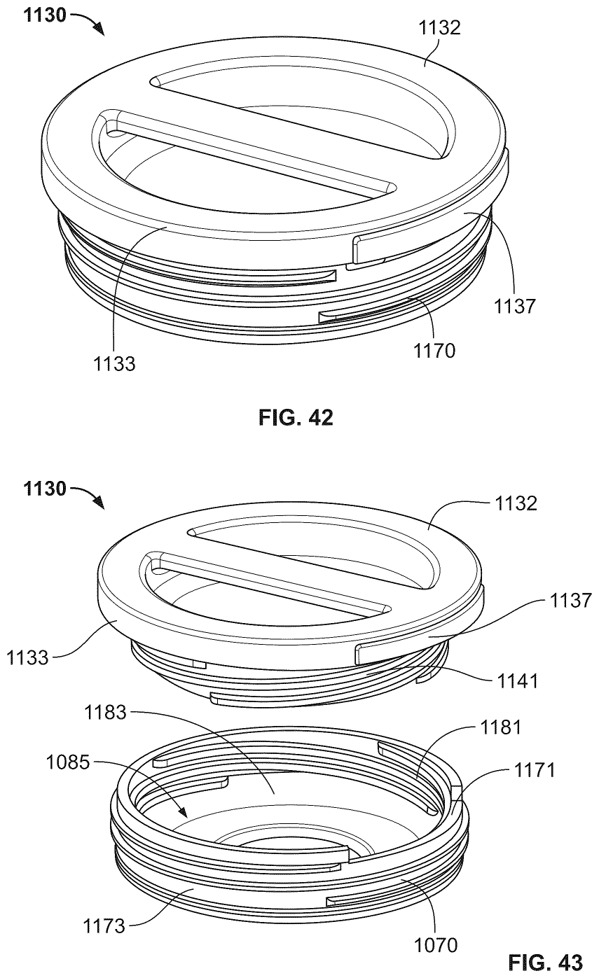

For the lid assembly 1130 of FIGS. 42-44D, the features are referred to using similar reference numerals under the “11xx” series of reference numerals, rather than “1xx” as used in the lid assembly 130 of FIGS. embodiment of FIGS. 1-17. Accordingly, certain features of the lid assembly 1130 that were already described above with respect to lid assembly 130 of FIGS. 1-17 may be described in lesser detail, or may not be described at all. Lid assembly 1130 may comprise an upper portion 1132 and a lower portion 1170 that are moveably coupled, where the upper portion 1132 can rotate relative to the lower portion 1170 and also move vertically relative to the lower portion 1170. As an alternative to or in addition to the magnetic coupling of the lid assembly 130, the upper portion 1132 and the lower portion 1170 may be mechanically coupled using corresponding engaging portions 1141, 1181 and a lever 1137 that is located along a side surface 1133 of the upper portion 1132. The upper portion 1132 may have an upper engaging portion 1141 (e.g., an external threaded portion) that engages a corresponding engaging portion 1181 (e.g., an internal threaded portion) on an interior surface 1183 of the lower portion 1170 such that the upper portion 1132 may be at least partially received within a cavity 1185 on an upper region of the lower portion 1170. The lever 1137 may be prevent separation of the upper portion 1132 and the lower portion 1170 and also limit the relative movement of the upper portion 1132 and the lower portion 1170 when they are coupled together.

The lever 1137 is pivotally connected to the side surface 1133 of the upper portion 1132. The pivot axis may be centrally located along the lever 1137. The lever 1137 may have a tab 1139 that extends from a lower surface of the lever 1137. When the upper portion 1132 is connected to the lower portion 1170, the tab 1139 is movably and or slidably engaged with a track 1171 located on an outer surface 1173 of the lower portion 1170. The tab 1139 remains in the track 1171 until an inward force is exerted on the side of the lever 1137 opposite the tab 1139, which causes the lever 1137 to pivot and the tab 1139 to move outward away from and out of the track 1171. Once the tab 1139 is out of the track 1171, the upper portion 1132 can be unscrewed from the lower portion 1170.

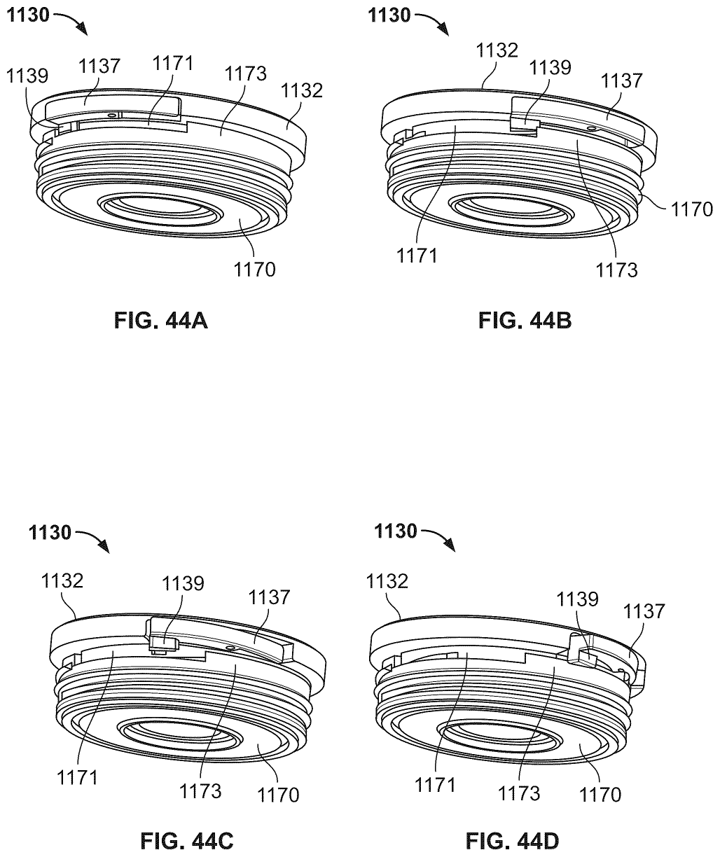

FIGS. 44A-44D illustrate an exemplary removal process. FIG. 44A illustrates the lid assembly 1130 in a fully sealed state with the lever 1137 and tab 1139 of the upper portion 1132 engaged within the track 1171 of the lower portion 1170. FIG. 44B illustrates the upper portion 1132 rotated relative to the lower portion 1170 to vent any gases from the interior of the container. The tab 1139 is limited in travel by the track 1171 to prevent the upper portion 1132 from separating from the lower portion 1170. FIG. 44C illustrates the lever 1137 being actuated by exerting an inward force on the side of the lever 1137 opposite the tab 1139 causing the lever 1137 to pivot and the tab 1139 to move outward away from and out of the track 1171 FIG. 44D illustrates the upper portion 1132 being further unscrewed from the lower portion 1170 since the tab 1139 is free from the track 1171.

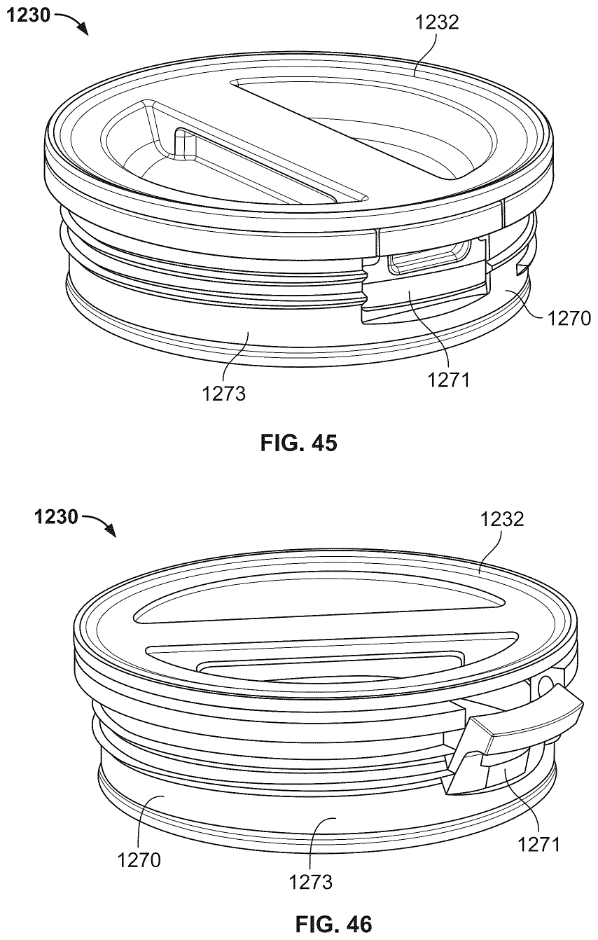

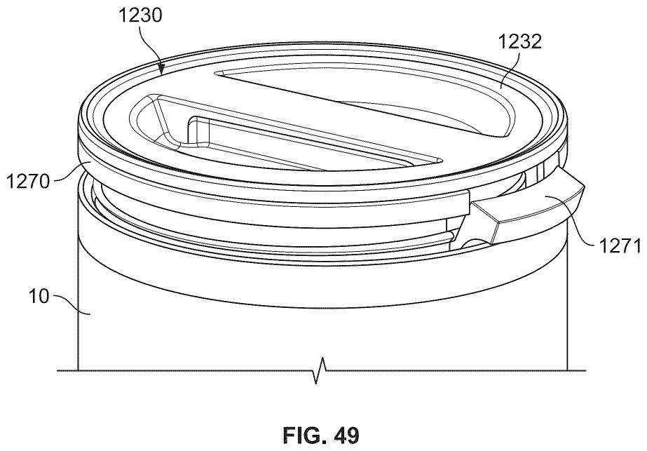

For the lid assembly 1230 of FIGS. 45-49, the features are referred to using similar reference numerals under the “11xx” series of reference numerals, rather than “1xx” as used in the lid assembly 130 of FIGS. embodiment of FIGS. 1-17. Accordingly, certain features of the lid assembly 1230 that were already described above with respect to lid assembly 130 of FIGS. 1-17 may be described in lesser detail, or may not be described at all. Lid assembly 1230 may comprise an upper portion 1232 and a lower portion 1270 that are moveably coupled, where the upper portion 1232 can rotate relative to the lower portion 1270 and also move vertically relative to the lower portion 1270. As an alternative to or in addition to the magnetic coupling of the lid assembly 130, the upper portion 1232 and the lower portion 1270 may be mechanically coupled using corresponding engaging portions 1241, 1281 and a latch 1271 that is located along a side surface 1273 of the lower portion 1270. The upper portion 1232 may have an upper engaging portion 1241 (e.g., an external threaded portion) that engages a corresponding engaging portion 1281 (e.g., an internal threaded portion) on an interior surface 1283 of the lower portion 1270 such that the upper portion 1232 may be at least partially received within a cavity 1285 on an upper region of the lower portion 1270. The latch 1271 may be prevent separation of the upper portion 1232 and the lower portion 1270 and also limit the relative movement of the upper portion 1232 and the lower portion 1270 when they are coupled together.

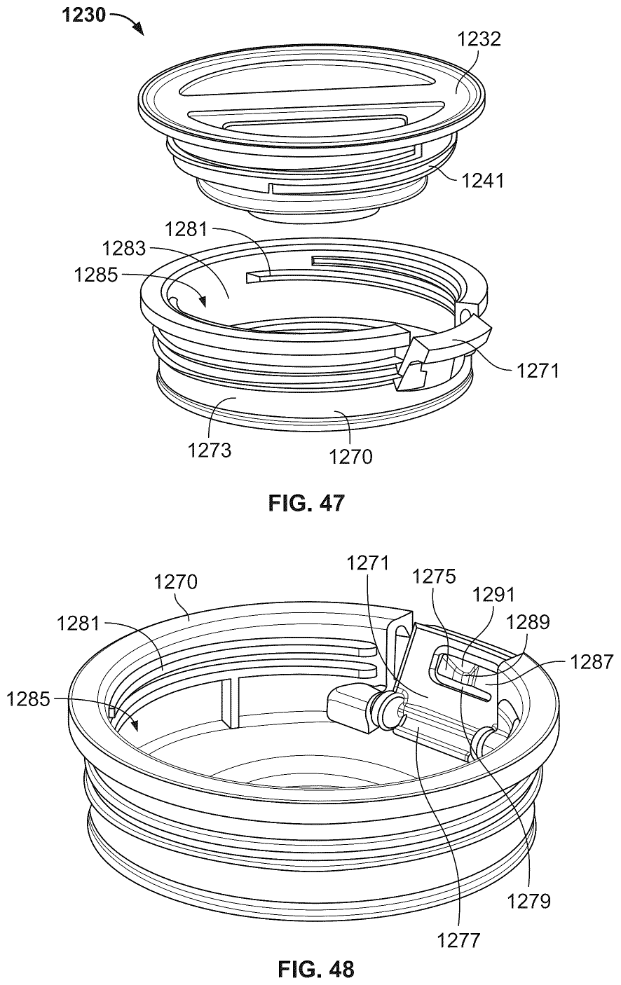

The latch 1271 may include a stop 1275 to prevent the upper portion 1232 from being removed from the lower portion 1270 when engaged. The latch 1271 may be pivotally connected to the lower portion 1270 at a lower portion of the latch 1271 along a side surface 1273 of the lower portion 1270. In some instances, the latch 1271 may include a detent or rib 1277 that provides a user with tactile feedback when the latch 1271 is in a locked position (as shown in FIG. 45) or unlocked position (as shown in FIGS. 46 and 47). The rib 1277 may interact with a surface on the interior of the lower portion 1270 to that increases or decreases the friction and ease of movement of the latch 1271 to provide the tactile feedback to the user. The body of the latch 1271 may include an opening 1279 and a stop 1275, which may be a cantilevered lever 1287. The cantilevered lever 1287 may extend into the opening 1279 and include a stop surface 1289 to that is configured to contact the engaging portions 1241 of the upper portion 1232 to prevent unscrewing the upper portion 1232 from the lower portion 1270. The lever 1287 may also include a ramped surface 1291 that allows the engaging portions 1241 to slide along such that the latch 1271 allows the upper portion 1232 to be screwed onto the lower portion 1270 when the latch is in a locked position. As best shown in FIG. 45, if the latch 1271 is in an unlocked position when attaching the lid assembly 1230 to a container 110, the container 110 may force the latch 1271 into the locked position to prevent the lid from accidentally opening when installed on a container 110.

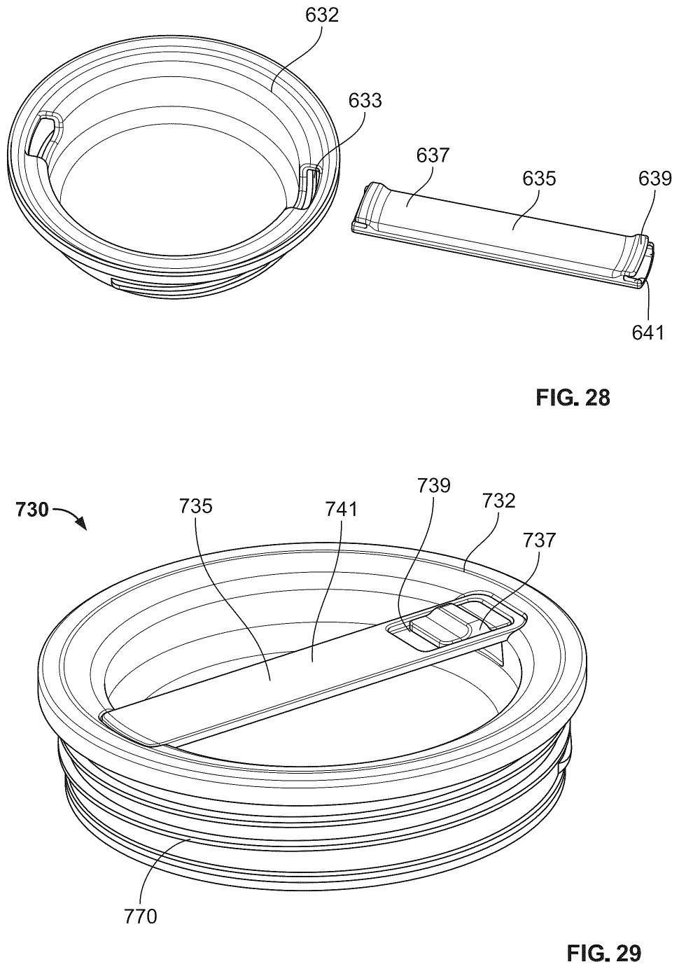

While the example lid assemblies illustrated in FIGS. 26-49 include an upper portion of the lid assembly with an exterior threaded portion that engages an interior threaded portion of a lower portion of the lid assembly, one skilled in the art would contemplate that the upper portion could be implemented with an external threaded portion that forms a continuous thread with an external threaded portion of the lower portion to engage in interior threaded portion of the container such as described in the lid assembly examples of FIGS. 1-20. The examples of mechanical coupling of the upper and lower portions of the lid assemblies of FIGS. 26-49 are options that could be implemented in the lid assembly examples of FIGS. 1-20.

In some examples, containers and lid assemblies described herein may be configured to contain liquid foods (e.g., soups, stews, etc.) or solid foods. In other examples, containers and lid assemblies described herein may be configured to contain beverages, including hot beverages (e.g., coffee, tea, etc.), cold beverages (e.g., water, juice, etc.), and carbonated beverages (e.g., soda, beer, etc.). Lid assemblies according to exemplary embodiments herein may be well suited for venting pressure created by the release of carbon dioxide from carbonated beverages.

The present disclosure is disclosed above and in the accompanying drawings with reference to a variety of examples. The various dimensions described above are merely exemplary and may be changed as necessary. Accordingly, it will be apparent to those of ordinary skill in the art that many more embodiments and implementations are possible that are within the scope of the claims. Therefore, the embodiments described are only provided to aid in understanding the claims and do not limit the scope of the claims.

We claim:

1. A container system comprising:
a container comprising:
a sidewall structure having a top end and a bottom end;
a bottom portion connected to the bottom end;
a container opening in the top end extending into a storage compartment; and
a container engaging portion located on an interior surface of the sidewall structure near the top end; and
a lid assembly adapted to seal the container opening, the lid assembly comprising:
an upper portion comprising:
a top wall;
a sidewall portion below the top wall, wherein the sidewall portion comprises an upper engaging portion that engages the container engaging portion;
a bottom wall connected to the sidewall portion;
a vent plug extending from the bottom wall; and
a lower portion releasably connected with the upper portion, the lower portion comprising:
a base;
a lower engaging portion engaged with the container engaging portion; and
a lower gasket configured to engage the interior surface of the container; and
a vent opening formed in the base, wherein when the container system is in a closed configuration, the vent plug is configured to contact the lower portion to seal the vent opening.

2. The container system of claim 1, wherein the container engaging portion comprises an internal threaded portion, and the upper engaging portion comprises a first external threaded portion and the lower engaging portion comprises a second external threaded portion.

3. The container system of claim 2, wherein the second external threaded portion has a thickness that is greater than a thickness of the first external threaded portion.

4. The container system of claim 2, wherein:
the upper portion and the lower portion are rotatably coupled,
in the closed configuration the first external threaded portion and the second external threaded portion form a single continuous thread,
in an open configuration the upper portion is rotated relative to the lower portion such that a gap is formed between the first external threaded portion and the second external threaded portion.

5. The container system of claim 1, wherein the vent plug of the upper portion comprises a receiver in a lower surface of the vent plug.

6. The container system of claim 5, wherein the lower portion comprises a recess, the recess of the lower portion is ring-shaped defining a projection, wherein the projection is at least partially received in the receiver when the container system is in the closed configuration.

7. The container system of claim 1, wherein:
the upper portion comprises an interior cavity that is at least partially enclosed by the top wall, the sidewall portion, and an upper magnet is secured within the interior cavity; and
the lower portion comprises a lower magnet and a magnetic force between the upper magnet and the lower magnet releasably connect the upper portion and the lower portion.

8. The container system of claim 1, wherein the upper portion and the lower portion are moveably coupled.

9. The container system of claim 8, wherein:
the bottom wall of the upper portion comprises a pocket formed in a bottom surface, wherein the pocket defines a first step and a second step, and
the lower portion comprises a tab extending upward from an upper surface, wherein the tab is configured to contact either the first step or the second step to stop relative movement of the upper portion and the lower portion.

10. The container system of claim 1, wherein a vent area is within a range of 1% and 15% of an opening area of the container opening.

11. A container system comprising:
a container comprising:
a sidewall structure having a top end and a bottom end;
a bottom portion connected to the bottom end;
a container opening in the top end extending into a storage compartment; and
a container engaging portion on an inner surface of the sidewall structure near the top end; and
a lid assembly adapted to seal the container opening, the lid assembly comprising:
an upper portion comprising:
a sidewall portion comprising an upper engaging portion that engages the container engaging portion;
a bottom wall connected to the sidewall portion;
a vent plug extending from the bottom wall;
a lower portion moveably coupled to the upper portion, the lower portion comprising:
a base;
a lower engaging portion that engages the container engaging portion;
a vent opening formed in the base; and
wherein when removing the lid assembly from the container, the upper portion moves relative to the lower portion causing the vent plug to be free of contact with the lower portion allowing air to escape from the storage compartment.

12. The container system of claim 11, wherein an opening torque required to begin removing the lid assembly from the container is less than or equal to 8 N*m when an internal pressure of the storage compartment is within a range of 8 psi and 17 psi.

13. The container system of claim 11, wherein a vent area is within a range of 1% and 33% of an opening area of the container opening.

14. The container system of claim 11, wherein the container engaging portion is an internal threaded portion, and the upper engaging portion is a first external threaded portion and the lower engaging portion is a second external threaded portion, and
wherein the first external threaded portion and the second external threaded portion when connected form a single continuous thread that engages the internal threaded portion.

15. The container system of claim 11, wherein the bottom wall of the upper portion includes a pocket formed in a bottom surface, wherein the pocket defines a first step and a second step, wherein the first step and the second step converge toward each other.

16. The container system of claim 15, wherein the lower portion comprises a tab extending upward from an upper surface, wherein the tab is configured to contact either the first step or the second step when the lid assembly is installed or removed.

17. A container system comprising:
a container comprising:
a sidewall structure having a top end and a bottom end;
a bottom portion connected to the bottom end;
a container opening in the top end extending into a storage compartment; and
an internal threaded portion on an inner surface of the sidewall structure near the top end; and
a lid assembly adapted to seal the container opening, the lid assembly comprising:
an upper portion comprising:
a sidewall portion that includes a first external threaded portion that engages the internal threaded portion;
a bottom wall connected to the sidewall portion;
a vent plug extending from the bottom wall;
and
a lower portion rotationally coupled to the upper portion; the lower portion comprising:
a base;
a second external threaded portion that engages the internal threaded portion;
a vent opening formed in the base; and
and
wherein when the container system is in a closed configuration, the first external threaded portion and the second external threaded portion form a single continuous thread; and wherein when the container system is in an open configuration, the upper portion is rotated relative to the lower portion such that a gap is formed between an end of the first external threaded portion and an end of the second external threaded portion.

18. The container system of claim 17, wherein the upper portion of the lid assembly further comprises a pocket formed in the bottom wall, wherein the pocket defines a step; and wherein the lower portion of the lid assembly further comprises a tab extending upward from the base; and
wherein the vent plug is configured to contact the lower portion to seal the vent opening when the container system is in the closed configuration; and
wherein when removing the lid assembly from the container, the upper portion moves relative to the lower portion a predetermined amount causing the vent plug to be free of contact with the lower portion allowing air to escape from the storage compartment, and as the upper portion moves beyond the predetermined amount, the tab contacts the step causing the lower portion to move in unison with the upper portion.

19. The container system of claim 17, wherein an opening torque required to begin removing the lid assembly from the container is less than or equal to 8 N*m when an internal pressure of the storage compartment is within a range of 8 psi and 17 psi.

20. The container system of claim 17, wherein the upper portion comprises an upper magnet and the lower portion comprises a lower magnet, wherein a magnetic force between the upper magnet and the lower magnet releasably connect the upper portion and the lower portion.
